(19) United States
(12) Patent Application Publication
(10) Pub. No.: US 2025/0142612 A1
(43) Pub. Date: May 1, 2025

(54) METHODS AND APPARATUSES FOR CONTROLLING TRANSMIT POWER LEVEL ACCORDING TO PREAMBLE BIT LENGTH

(71) Applicant: Microchip Technology Incorporated, Chandler, AZ (US)

(72) Inventor: Yifeng Yang, Chandler, AZ (US)

(21) Appl. No.: 18/929,350

(22) Filed: Oct. 28, 2024

Related U.S. Application Data
(60) Provisional application No. 63/594,916, filed on Oct. 31, 2023.

(51) Int. Cl. H04W 72/542

(52) U.S. Cl. CPC H04W 72/542

(57) ABSTRACT

In one example, a method of a transceiver comprises receiving a first communication signal including a first message; detecting a signal strength of the first communication signal; generating a preamble having a preamble bit length that is adjusted at least partially based on the detected signal strength of the first communication signal; and transmitting a second communication signal including a second message, the second message including the preamble having the preamble bit length.

### CROSS-REFERENCE TO RELATED APPLICATIONS

This application claims the benefit under 35 U.S.C. § 119(e) of U.S. Provisional Patent Application No. 63/594,916, filed Oct. 31, 2023, and titled “Apparatus and Method for Controlling Transmit Power Level According to Preamble Length,” the entire disclosure of which is hereby incorporated herein by reference.

### TECHNICAL FIELD

This disclosure relates generally to transceivers, and more particularly to methods and apparatuses for controlling a transmit power level of a transceiver according to a preamble bit length of a preamble of a message.

### BACKGROUND

In a transceiver, it is desirable to reduce the power of transmitted signals so long as it does not adversely affect the communication of messages carried by the signals. In one or more examples, the transceiver may be a battery-powered wireless transceiver for use in a wireless personal area network.

### BRIEF DESCRIPTION OF THE DRAWINGS

While this disclosure concludes with claims particularly pointing out and distinctly claiming specific examples, various advantages of examples within the scope of this disclosure may be more readily ascertained from the following description when read in conjunction with the accompanying drawings, in which:

FIG. 1 is a depiction of a communication system including a transceiver of a first communication device and a transceiver of a second communication device, according to one or more examples;

FIG. 2 depicts a preamble of a message communicated between the transceivers of FIG. 1;

FIGS. 3A, 3B, and 3C depict a preamble having a variable preamble bit length for transmit power level control, according to one or more examples;

FIG. 4A is a message flow diagram of a message flow of messages that are wirelessly communicated between transceivers for transmit power level control, according to one or more examples;

FIG. 4B is a message flow diagram of a message flow of messages that are wirelessly communicated between transceivers for transmit power level control, according to one or more examples;

FIG. 5A is a flowchart of a method of a first transceiver to control a transmit power level of a second transceiver according to a preamble bit length of a preamble, according to one or more examples;

FIG. 5B is a flowchart of a more detailed method of a first transceiver to control a transmit power level of a second transceiver according to a preamble bit length of a preamble, according to one or more examples;

FIG. 6A is a flowchart of a method of a second transceiver to control a transmit power level according to preamble bit length of a preamble received from a first transceiver, according to one or more examples;

FIG. 6B is a flowchart of a more detailed method of a second transceiver to control a transmit power level according to preamble bit length of a preamble received from a first transceiver, according to one or more examples;

FIG. 7 is a block diagram of a communication device including a transceiver PHY, according to one or more examples;

FIG. 8 is a schematic block diagram of an electronic circuitry in a transceiver (e.g., a transceiver PHY) for controlling a transmit power level according to preamble bit length, according to one or more examples;

FIG. 9 is a schematic block diagram of a preamble sequence generator circuit of the electronic circuitry of FIG. 8 for controlling a transmit power level according to preamble bit length, according to one or more examples;

FIG. 10 is a schematic block diagram of an electronic circuitry in a transceiver (e.g., a transceiver PHY) for controlling a transmit power level according to preamble bit length, according to one or more examples;

FIG. 11 is a schematic block diagram of an electronic circuitry in a transceiver for controlling a transmit power level according to preamble bit length, according to one or more examples;

FIG. 12 is a schematic block diagram of an electronic circuitry in a transceiver for controlling a transmit power level according to preamble bit length, according to one or more examples;

FIG. 13 is a flowchart of a method of controlling a transmit power level according to preamble bit length using one or more counter circuits, according to one or more examples;

FIG. 14 is a protocol stack associated with an Institute of Electrical and Electronics Engineers (IEEE) 802.15.4 standard for low-rate wireless personal area networks (LR-WPANs); and

FIG. 15 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an examples or this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the present disclosure, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Wireless output power is characterized by the inverse distance square law: when the distance between wireless transceivers is doubled, four (4) times the output power for transmission should be used. In some wireless systems, a wireless transceiver operates to (e.g., always) output the maximum power without knowledge and regardless of the distance of the other wireless transceiver. That is, some existing solutions utilize a constant maximum output power for transmission, which in some instances may be inefficient or wasteful. If feedback could be provided, however, savings in power could be achieved. To illustrate by example, if the maximum range of a wireless transceiver is twenty (20) meters, and it is known that the other wireless transceiver is only ten (10) meters away, the wireless transceiver may only need to transmit one-quarter (¼) of the output power. Such a decrease would be a significant savings in power, and especially valuable for embedded devices that are powered by one or more batteries.

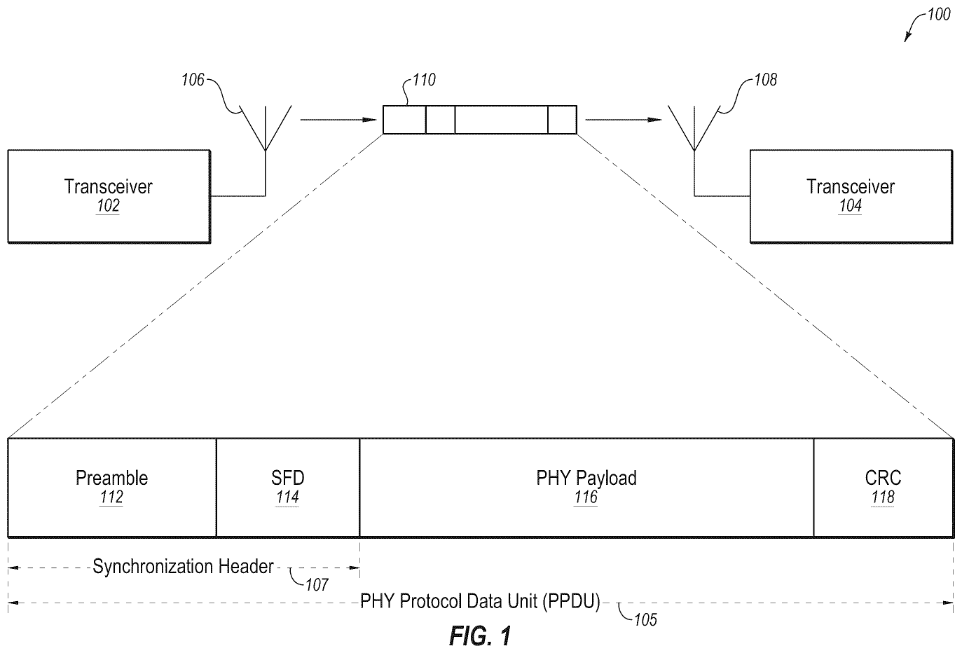

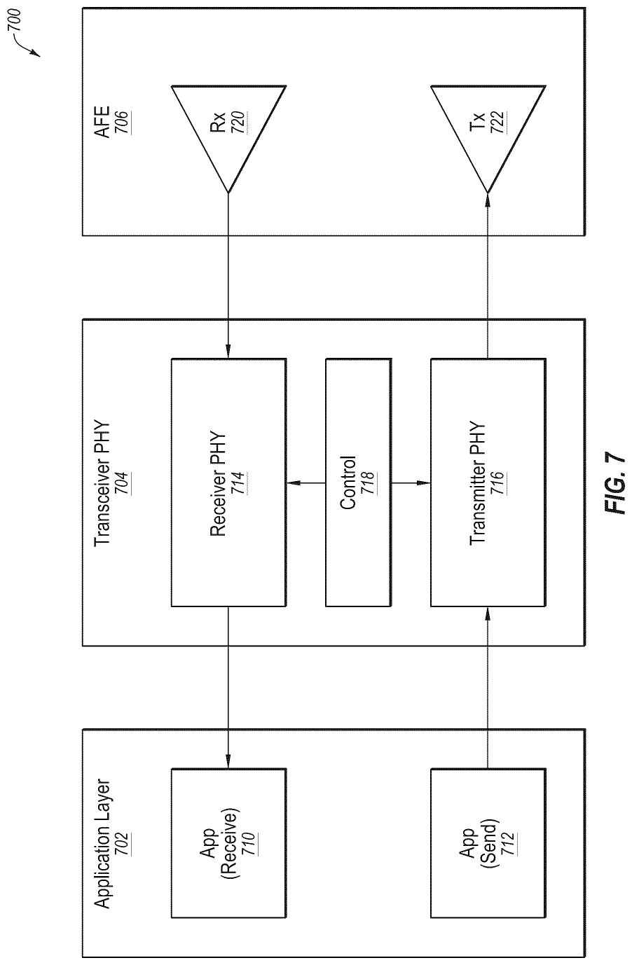

FIG. 1 is a depiction of a communication system 100 including a transceiver 102 of a first communication device and a transceiver 104 of a second communication device, according to one or more examples. Respective ones of transceivers 102 and 104 include at least a transmitter portion and a receiver portion. In one or more examples, respective ones of transceivers 102 and 104 are or include a transceiver PHY which is a part of a communication device shown and described later in relation to FIG. 7.

In one or more examples, transceiver 102 and transceiver 104 communicate with each other via wireless communication signals. Here, transceiver 102 may be or include a wireless transceiver including an antenna 106 for transmission of a wireless communication signal which is received at transceiver 104, and transceiver 104 may be or include a wireless transceiver including an antenna 108 for transmission of a wireless communication signal which is received at transceiver 102.

In one or more examples, transceiver 102 and transceiver 104 communicate messages to each other according to a predetermined communication protocol. The predetermined communication protocol may be part of a communication standard (e.g., a communication standard adopted by an industry). In one or more examples, transceiver 102 and transceiver 104 communicate with each other in accordance with a wireless personal area network (WPAN) standard, such as a low-rate (LR) WPAN (LR-WPAN) standard or Institute of Electrical and Electronics Engineers (IEEE) 802.15.4.

In one or more alternative examples, transceiver 102 and transceiver 104 communicate with each other in accordance with a different communication standard, such as a Bluetooth or Bluetooth Low Energy (BLE) standard (e.g., BLUETOOTH® Core Specification), a sub-GHz standard (e.g., IEEE 802.15.4g), a Wi-Fi standard (e.g., IEEE 802.11), and so on. BLUETOOTH® is a registered trademark of the Bluetooth Special Interest Group (SIG), Inc., of Kirkland, Washington, USA.

As depicted in FIG. 1, transceiver 102 may communicate a wireless communication signal including a message 110 to transceiver 104. In one or more examples, message 110 includes a PHY protocol data unit (PPDU) 105 associated with a communication standard (e.g., the IEEE 802.15.4 standard). In one or more examples, message 110 has a message format including a synchronization header (SHR) 107 having a preamble 112 and a start frame delimiter (SFD) 114, a payload 116 (e.g., a PHY payload), and a cyclical redundancy check (CRC) 118. SHR 107 including preamble 112 is used at least for synchronization of timing between transceivers 102 and 104. SFD 114 is to indicate an end of preamble 112 and a start of payload 116. CRC 118 is used to ensure the integrity of payload 116.

Respective ones of transceivers 102 and 104 include a state machine. When the wireless communication signal including message 110 is communicated from transceiver 102 to transceiver 104, preamble 112 of SHR 107 places the receiver portion of transceiver 104 in a predetermined state. After receiving SFD 114, the receiver portion is engaged to receive and save the PHY content from payload 116. After receiving CRC 118, the receiver portion checks the integrity of the PHY content. The received signal strength of the wireless communication signal is evaluated via an analog-to-digital converter (ADC). In one or more example environments, where the receiver portion has a receiver sensitivity of −90 decibel milliwatts (dBm): if the received signal is −80 dBm, the signal strength is adequate; if the received signal is −75 dBm or more, the signal is too strong (e.g., battery power of transceiver 102 is being wasted); if the received signal is −85 dBm or less, the signal is too weak (e.g., data is not being received adequately at transceiver 104).

According to one or more examples, transceivers 102 and 104 may use a preamble bit length of preamble 112 of message 110 to control or adjust the transmit power level. According to one or more examples, respective ones of transceivers 102 and 104 instruct the other transceiver to adjust its transmit power level according to a preamble bit length of the preamble. In one or more examples, a transceiver detects a preamble bit length of a preamble of a message received from the other transceiver, and adjusts, based on the preamble length, a transmit power level of a communication signal for transmission to the other transceiver. In one or more other examples, a transceiver detects a signal strength of a first communication signal from another transceiver, and in response, transmits a second communication signal to the other transceiver with a message having a preamble with a preamble bit length adjusted based on the detected signal strength. Here, the preamble having the preamble bit length is used to adjust a transmit power level used for transmission at the other transceiver.

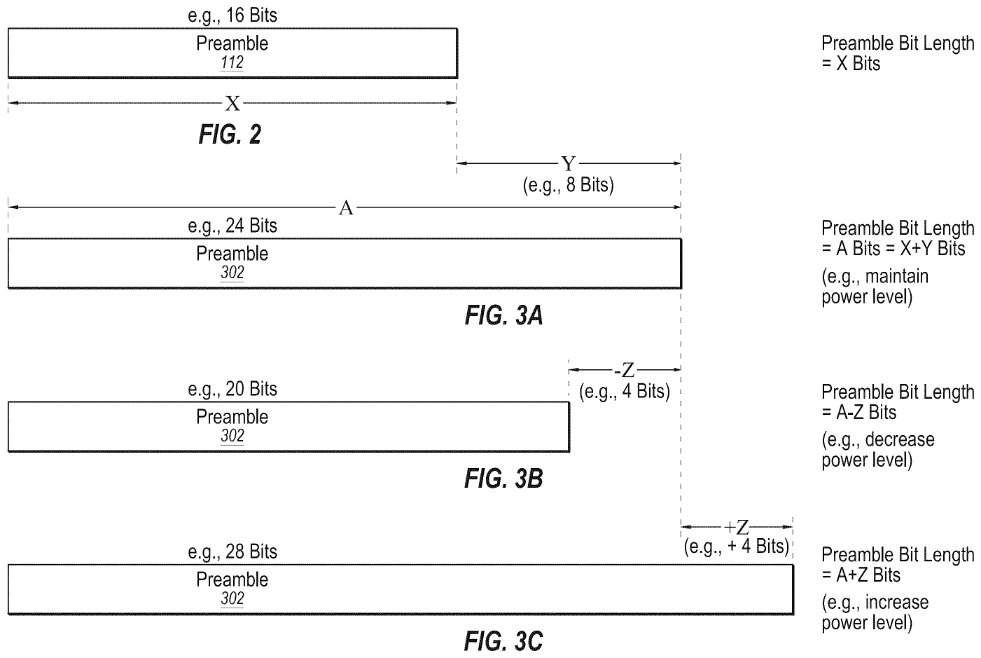

FIG. 2 depicts preamble 112 of message 110 communicated between transceivers 102 and 104 of FIG. 1. Preamble 112 may include a predetermined bit sequence or pattern of binary values (e.g., +1 or −1 values). Preamble 112 including the predetermined bit sequence has a preamble bit length defined by a predetermined number of bits, where respective ones of the bits have the same duration. In FIG. 2, preamble 112 is indicated to have a preamble bit length of X bits. Preamble 202 having the bit length of X bits may be one that is typically or commonly used for communications (e.g., in a particular wireless communication system), one that is a minimum preamble bit length used for communications, and/or one that is specified or indicated in a technical specification of a communication standard for communications.

In the specific, non-limiting example of FIG. 2, preamble 112 has a preamble bit length of sixteen (16) bits (i.e., X=16 bits), compatible with the communication standard associated with IEEE 802.15.4. Here, the predetermined bit sequence or pattern is a 16-bit sequence of alternating +1 and −1 binary values. In one or more other examples, the preamble bit length of preamble 112 may be thirty-two (32) bits (i.e., X=32 bits).

FIGS. 3A, 3B, and 3C depict a preamble 302 having a variable preamble bit length for transmit power level control, according to one or more examples. In one or more examples, preamble 302 of FIGS. 3A, 3B, and 3C is compatible the communication standard associated with preamble 112 of FIG. 2 (i.e., IEEE 802.15.4). In one or more examples, respective ones of preambles 302 of FIGS. 3A, 3B, and 3C have the same preamble sequence or pattern (e.g., the alternating +1 and −1 binary values), but different respective bit lengths.

In one or more examples, preamble 302 of FIG. 3A has a preamble bit length of A bits, preamble 302 of FIG. 3B has a preamble bit length of (A-Z) bits, and preamble 302 of FIG. 3C has a preamble bit length of (A+Z) bits. Here, A and Z are predetermined positive integer constants, where A>Z. In one or more further examples, A bits=(X+Y) bits, where X is a predetermined preamble bit length of a preamble specified in a communication standard with which the transceivers are compatible (e.g., IEEE 802.15.4), X and Y are predetermined positive integer constants, and Y>Z.

In one or more examples, when transmitted from a first transceiver, preamble 302 of FIG. 3A having the preamble bit length of A bits is to control a second transceiver to maintain its current transmit power level. When received at the second transceiver, preamble 302 of FIG. 3A having the preamble bit length of A bits causes the current transmit power level of the second transceiver to be maintained (i.e., the current transmit power level does not change).

In one or more examples, when transmitted from the first transceiver, preamble 302 of FIG. 3B having the preamble bit length of (A-Z) bits is to control the second transceiver to decrease its current transmit power level. When received at the second transceiver, preamble 302 of FIG. 3B having the preamble bit length of (A-Z) bits causes the current transmit power level of the second transceiver to be decreased. In one or more examples, preamble 302 of FIG. 3B having the preamble bit length of (A-Z) bits causes the transmit power level to be decreased by a predetermined adjustment amount for an incremental decrease in transmit power level.

In one or more examples, when transmitted from the first transceiver, preamble 302 of FIG. 3C having the preamble bit length of (A+Z) bits is to control the second transceiver to increase its current transmit power level. When received at the second transceiver, preamble 302 of FIG. 3C having the preamble bit length of (A+Z) bits causes the current transmit power level of the second transceiver to be increased. In one or more examples, preamble 302 of FIG. 3C having the preamble bit length of (A+Z) bits causes the transmit power level to be increased by the predetermined adjustment amount for an incremental increase in transmit power level.

In a specific, non-limiting example, X=16 bits for the communication standard associated with IEEE 802.11 (e.g., preamble 112 of FIG. 2). Even more specifically, Y=8 bits and Z=4 bits. When X=16 bits, Y=8 bits, and Z=4 bits, the preamble bit length of A=(16+8) bits=24 bits (FIG. 3A); the preamble bit length of (A−Z) bits=(24−4) bits=20 bits (FIG. 3B); and the preamble bit length of (A+Z) bits=(24+4) bits=28 bits (FIG. 3C).

In one or more alternative examples, X=32 bits, Y=8 bits, and Z=4 bits. When X=32 bits, Y=8 bits, and Z=4 bits, the preamble bit length of A=(32+8) bits=40 bits; the preamble bit length of (A−Z) bits = (32−4) bits=28 bits; and the preamble bit length of (A+Z) bits=(32+4) bits=36 bits.

In one or more examples, the value of Y is selected to be greater than a tolerance of allowable missing preamble bits (e.g., T bits) for valid detection of the preamble. A receiver PHY may not receive each and every preamble bit of the preamble in its detection of the preamble by the receiver portion of the transceiver. Rather, the receiver PHY can be adapted to tolerate a certain number of missing bits of the preamble while still considering the preamble to be valid and/or detected. In one or more examples, for X=16 bits, the tolerance of allowable missing preamble bits for a valid detected preamble is T=1; therefore, Y may be selected to be any positive integer greater than or equal to two (2). In one or more other examples, for X=16 bits, the tolerance of allowable missing preamble bits for a valid detected preamble is T=3; therefore, Y may be selected to be any positive integer greater than or equal to four (4). On the other hand, in one or more alternative examples, the receiver tolerance is zero (i.e., T=0), where Y may be chosen to be any positive integer (i.e. Y>0).

In one or more other examples, any suitable number of bits may be used for the preamble bit lengths and/or values of X, Y, A, and Z. In one or more other examples, different preamble bit lengths may be utilized to provide for different respective transmit power level controls (e.g., a preamble bit length of (A−Z) bits may be used to instruct an increase in transmit power level, and a preamble bit length of (A+Z) bits may be used to instruct a decrease in transmit power level). In one or more other examples, the preamble bit lengths may be utilized to provide for control (e.g., PHY-level control) that is different from transmit power level control (e.g., variable preamble bit lengths may be utilized to provide for signal frequency control; for example, to maintain, increase, or decrease a transmit signal frequency or a receive signal frequency).

In one or more alternative examples, a preamble bit length of X bits is used to maintain the current transmit power level, a preamble bit length of (X+J) bits is used to increase the current transmit power level, and a third preamble bit length of (X+K) bits is used to decrease the current transmit power level. Here, X is a predetermined preamble bit length of a preamble specified in a communication standard with which the transceiver is compatible (e.g., IEEE 802.15.4), X, J, and K are predetermined positive integer constants, and J≠K. Here, in one or more examples for compatibility with IEEE 802.15.4, X=16 bits, J=8 bits, and K=16 bits (i.e., bit lengths which match the respective bit lengths associated with preamble 112 of FIG. 2, preamble 302 of FIG. 3A, and preamble 302 of FIG. 3C). In one or more alternative examples, X=32 bits, J=8 bits, and K=16 bits.

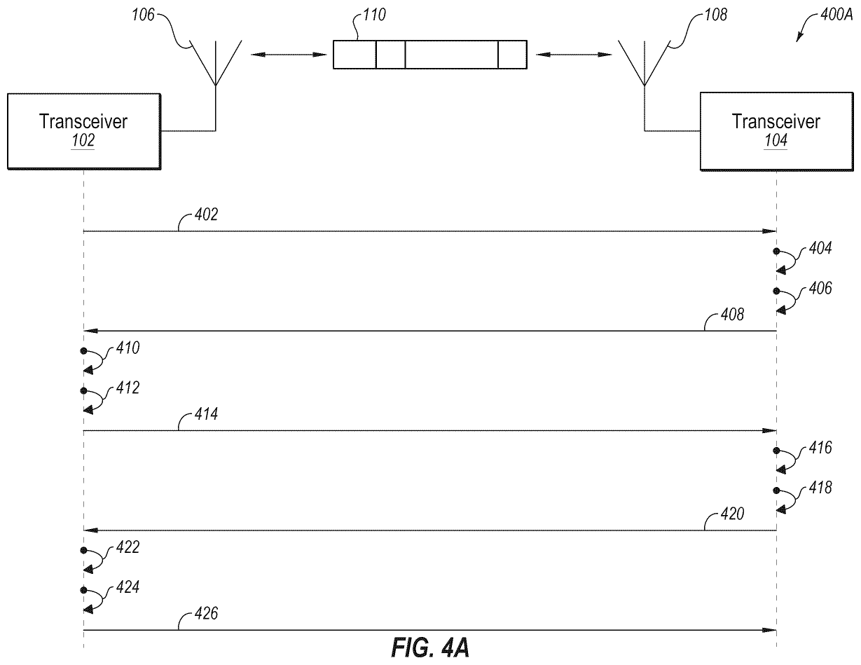

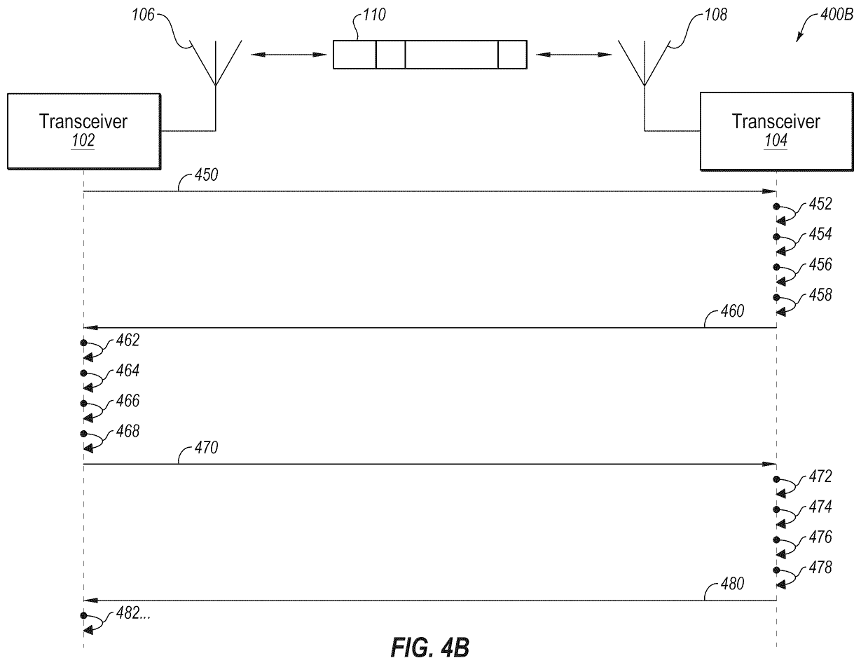

FIG. 4A is a message flow diagram of a message flow 400A of messages that are wirelessly communicated between transceiver 102 and transceiver 104 for transmit power level control, according to one or more examples. Message flow 400A indicates processing for transmit power level control according to preamble bit length, according to one or more examples. In one or more examples, acts of message flow 400A are implemented in transceiver PHYs (e.g., in PHY circuitry) for end-to-end PHY-level control of the transmit power level.

In message flow 400A, transceiver 102 transmits, to transceiver 104, a first communication signal including a first message (e.g., message 110), at an act 402. Transceiver 104 receives, from transceiver 102, the first communication signal including the first message. Transceiver 104 detects a signal strength of the first communication signal, at an act 404. Transceiver 104 generates a preamble having a preamble bit length, at an act 406. In generating the preamble at act 406, transceiver 104 adjusts the preamble bit length of the preamble based on the detected signal strength of the first communication signal. Transceiver 104 transmits, to transceiver 102, a second communication signal including a second message, at an act 408. The second message includes the preamble having the preamble bit length adjusted based on the detected signal strength of the first communication signal. In one or more examples, when transceiver 102 transmits to transceiver 104 an initial communication signal (e.g., the first communication signal including the first message, at act 402), transceiver 102 transmits the initial communication signal at a maximum output power of transceiver 102.

In one or more examples, the signal strength at transceiver 104 is detected to be too high at act 404, and in response, the preamble bit length of the preamble is adjusted to be a first preamble bit length at act 406. In one or more examples, the first preamble bit length is to instruct transceiver 102 to decrease its transmit power level. In one or more other examples, the signal strength at transceiver 104 is detected to be too low at act 404, and in response, the preamble bit length of the preamble is adjusted to be a second preamble bit length at act 406. In one or more other examples, the second preamble bit length is to instruct transceiver 102 to increase its transmit power level.

From act 408, transceiver 102 receives, from transceiver 104, the second communication signal including the second message. Transceiver 102 performs synchronization using the preamble of the second message. Transceiver 102 detects the preamble bit length of the preamble of the second message, at an act 410. Transceiver 102 adjusts, based on the preamble bit length, a transmit power level for transmission, at an act 412. Transceiver 102 transmits, to transceiver 104, a third communication signal including a third message at the adjusted transmit power level, at an act 414.

In one or more examples, the preamble bit length of the preamble is detected to be the first preamble bit length at act 410, and in response, the transmit power level is increased at act 412. In one or more other examples, the preamble bit length of the preamble is detected to be the second preamble bit length at act 410, and in response, the transmit power level is decreased at act 412.

From act 414, transceiver 104 receives, from transceiver 102, the third communication signal including the third message. Transceiver 104 detects a signal strength of the third communication signal, at an act 416. Transceiver 104 generates a preamble having a preamble bit length, at an act 418. In generating the preamble at act 418, transceiver 104 adjusts the preamble bit length of the preamble based on the detected signal strength of the third communication signal. Transceiver 104 transmits, to transceiver 102, a fourth communication signal including a fourth message, at an act 420. The fourth message includes the preamble having the preamble bit length adjusted based on the detected signal strength of the third communication signal.

In one or more examples, the signal strength at transceiver 104 is detected to be an adequate signal strength (e.g., within a target threshold range) at act 416, and in response the preamble bit length of the preamble is adjusted to be a third preamble bit length at act 418. In one or more examples, the third preamble bit length is to instruct transceiver 102 to maintain its (current) transmit power level.

From act 420, transceiver 102 receives, from transceiver 104, the fourth communication signal including the fourth message. Transceiver 102 performs synchronization using the preamble of the fourth message. Transceiver 102 detects the preamble bit length of the preamble of the fourth message, at an act 422. Transceiver 102 adjusts, responsive the detected preamble bit length, a transmit power level for transmission, at an act 424. Transceiver 102 transmits, to transceiver 104, a fifth communication signal including a fifth message at the adjusted transmit power level, at an act 426.

In one or more alternative examples, the preamble bit length of the preamble is detected to be the third preamble bit length at act 422, and in response, the transmit power level is maintained at act 424. The fifth communication signal from transceiver 102 to transceiver 104 may have a sufficient or optimal signal strength so that no further adjustments are needed (e.g., for at least some period of time thereafter).

According to one or more examples, respective ones of transceivers 102 and 104 may be adapted with the same or similar adjustment capabilities on each end, as will be described in relation to FIG. 4B.

FIG. 4B is a message flow diagram of a message flow 400B of messages that are wirelessly communicated between transceiver 102 and transceiver 104 for transmit power level control, according to one or more examples. Message flow 400B indicates processing for transmit power level control according to preamble bit length, according to one or more examples. In one or more examples, acts of message flow 400B are implemented in transceiver PHYs (e.g., in PHY circuitry) for end-to-end PHY-level control of the transmit power level. In one or more examples of FIG. 4B, respective ones of transceivers 102 and 104 are adapted with the same or similar adjustment capabilities on each end.

In message flow 400B, transceiver 102 transmits, to transceiver 104, a first communication signal including a first message (e.g., message 110), at an act 450. The first message includes a preamble having a preamble bit length. Transceiver 104 receives, from transceiver 102, the first communication signal including the first message. Transceiver 104 performs synchronization using the preamble of the first message. Transceiver 102 detects the preamble bit length of the preamble of the first message, at an act 452. Transceiver 102 adjusts, based on the detected preamble bit length, a transmit power level for transmission, at an act 454. In one or more examples, when transceiver 102 transmits to transceiver 104 an initial communication signal (e.g., the first communication signal including the first message, at act 450), transceiver 102 transmits the initial communication signal at a maximum output power of transceiver 102.

Transceiver 104 further detects a signal strength of the first communication signal, at an act 456. Transceiver 104 generates a preamble with a preamble bit length, at an act 458. In generating the preamble at act 456, transceiver 104 adjusts the preamble bit length of the preamble based on the detected signal strength. Transceiver 104 transmits, to transceiver 102, at the adjusted transit power level, a second communication signal including the second message, at an act 460. The second message includes the preamble having the preamble bit length adjusted based on the detected signal strength.

In one or more examples, the preamble bit length is detected to be a first preamble bit length at act 452, and in response, the transmit power level is decreased at act 454. In one or more other examples, the preamble bit length is detected to be a second preamble bit length at act 452, and in response the transmit power level is increased at act 454.

In one or more examples, the signal strength at transceiver 104 is detected to be too high at act 456, and in response, the preamble bit length is adjusted to be the first preamble bit length at act 458. In one or more examples, the first preamble bit length is to instruct transceiver 102 to decrease its transmit power level. In one or more other examples, the signal strength at transceiver 104 is detected to be too low at act 456, and in response, the preamble bit length is adjusted to be the second preamble bit length at act 458. In one or more examples, the second preamble bit length is to instruct transceiver 102 to increase its transmit power level.

From act 460, transceiver 102 receives, from transceiver 104, the second communication signal including the second message. Transceiver 102 performs synchronization using the preamble of the second message. Transceiver 102 detects the preamble bit length of the preamble of the second message, at an act 462. Transceiver 102 adjusts, based on the detected preamble bit length, a transmit power level for transmission, at an act 464. Transceiver 102 detects a signal strength of the second communication signal, at an act 466. Transceiver 102 generates a preamble with a preamble bit length, at an act 468. In generating the preamble at act 468, the preamble bit length of the preamble is adjusted based on the detected signal strength. Transceiver 102 transmits, to transceiver 104, at the adjusted power level, a third communication signal including a third message, at an act 470. The third message includes the preamble having the preamble bit length adjusted based on the detected signal strength.

In one or more examples, the preamble bit length of the preamble is detected to be the first preamble bit length at act 462, and in response, the transmit power level is decreased at act 464. In one or more other examples, the preamble bit length of the preamble is detected to be the second preamble bit length at act 462, and therefore the transmit power level is increased at act 464.

In one or more examples, the signal strength at transceiver 102 is detected to be (e.g., still) too high at act 466, and in response, the preamble bit length is adjusted to be the first preamble bit length at act 468. In one or more examples, the first preamble bit length is to instruct transceiver 104 to decrease its transmit power level. In one or more other examples, the signal strength at transceiver 102 is detected to be (e.g., still) too low at act 466, and in response, the preamble bit length is adjusted to be the second preamble bit length at act 468. In one or more examples, the second preamble bit length is to instruct transceiver 104 to decrease its transmit power level.

From act 470, transceiver 104 receives, from transceiver 102, the third communication signal including the third message. Transceiver 104 performs synchronization using the preamble of the third message. Transceiver 104 detects the preamble bit length of the preamble of the message, at an act 472. Transceiver 104 adjusts, based on the detected preamble bit length, a transmit power level for transmission, at an act 474. Transceiver 104 also detects a signal strength of the communication signal, at an act 476. Transceiver 104 generates a preamble having a preamble bit length, at an act 478. In generating the preamble at act 478, transceiver 104 adjusts the preamble bit length of the preamble based on the detected signal strength of the third communication signal. Transceiver 104 transmits, to transceiver 102 a fourth communication signal including a fourth message, at an act 480. The fourth message includes the preamble having the preamble bit length adjusted based on the detected signal strength of the third communication signal.

In one or more alternative examples, the preamble bit length of the preamble is detected to be the third preamble bit length at act 472, and in response, the transmit power level is maintained at act 474. In one or more examples, the signal strength at transceiver 104 is detected to be an adequate signal strength (e.g., within a target threshold range) at act 476, and in response, the preamble bit length of the preamble is adjusted to be a third preamble bit length at act 478. In one or more examples, the third preamble bit length is to instruct transceiver 102 to maintain its (current) transmit power level.

From act 480, transceiver 102 receives, from transceiver 104, the fourth communication signal including the fourth message. Transceiver 102 performs synchronization using the preamble of the fourth message. Transceiver 102 detects the preamble bit length of the preamble of the fourth message, at an act 482. Then, acts of transceiver 102 and transceiver 104 may repeat and/or continue in the same or similar manner as described above.

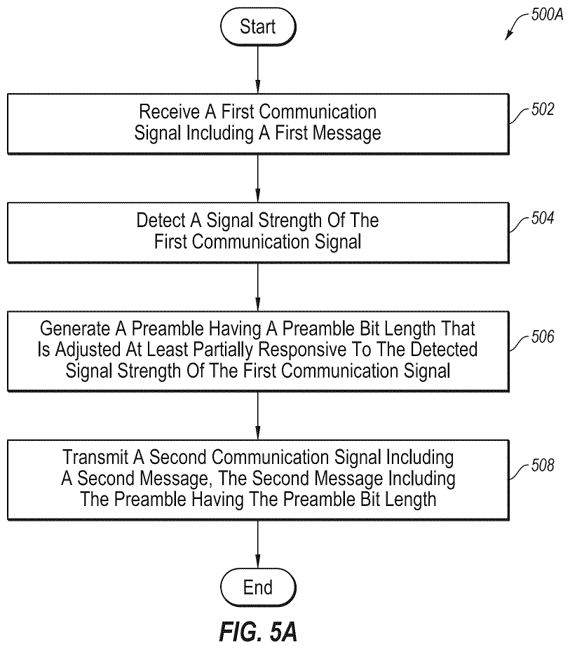

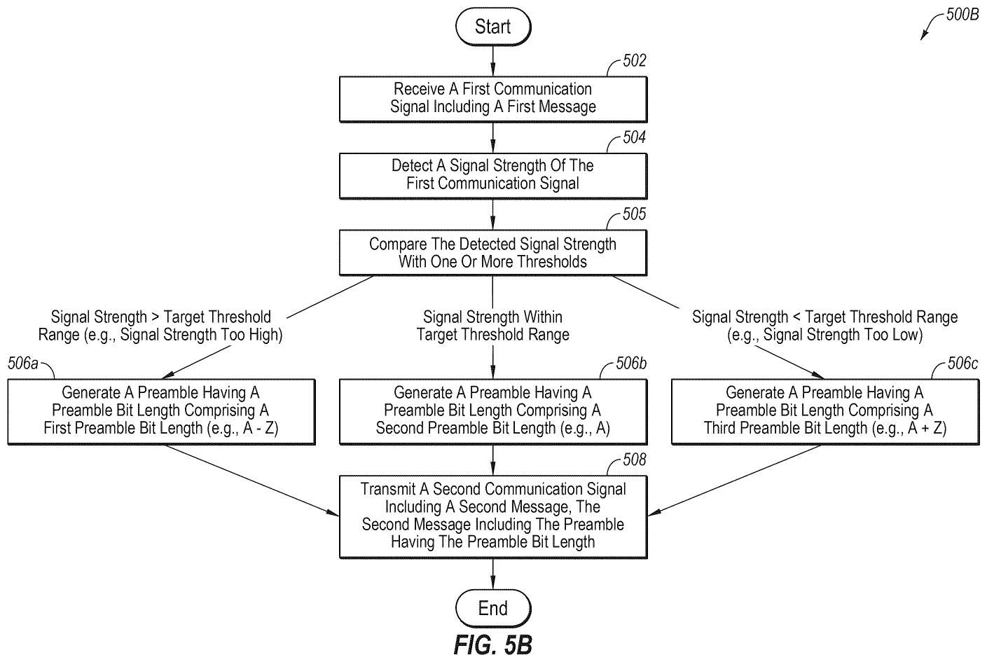

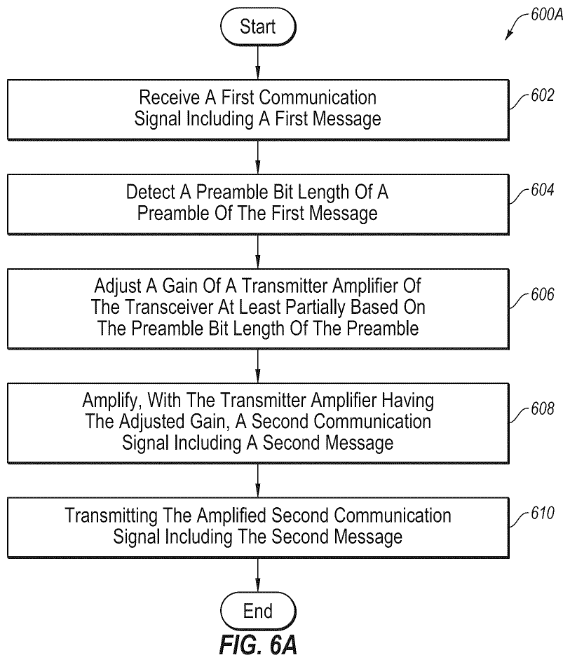

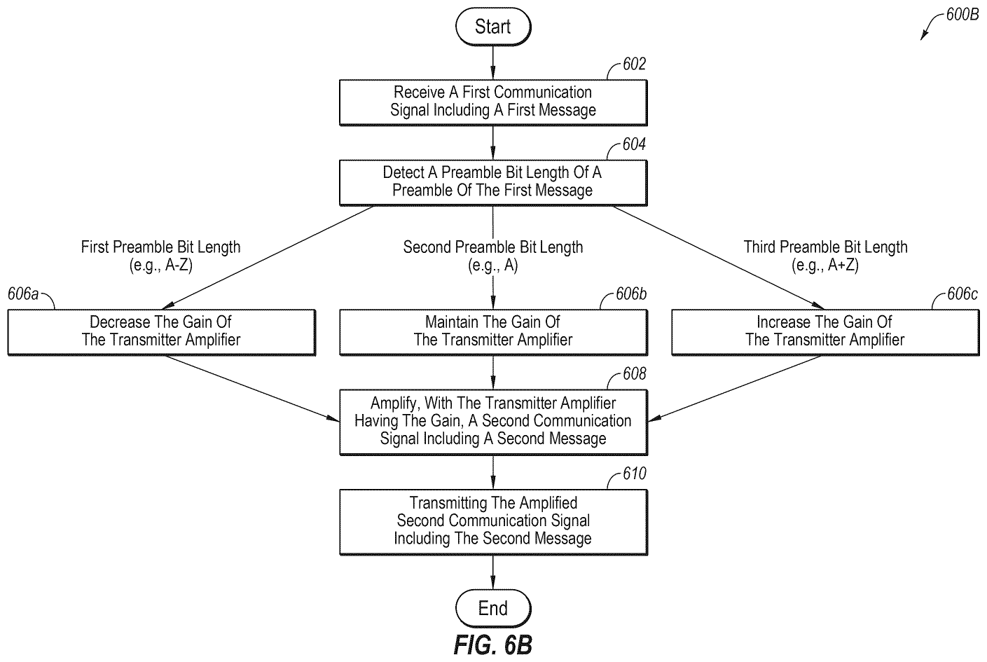

FIG. 5A is a flowchart of a method 500A of a first transceiver to control a transmit power level of a second transceiver according to preamble bit length of a preamble, according to one or more examples. Method 500A may be performed by a transceiver (e.g., transceiver 102 and/or transceiver 104 of FIG. 1). In one or more examples, acts of method 500B are implemented in a transceiver PHY (e.g., in PHY circuitry) for PHY-level control of the transmit power level. In one or more examples, transceiver 102 operates to perform method 500A of FIG. 5A for communication with and transmit power level control of transceiver 104 which operates to perform a method 600A of FIG. 6A (e.g., refer to message flow 400A of FIG. 4A). In one or more specific examples, respective ones of transceiver 102 and transceiver 104 operate to perform both method 500A of FIG. 5A and method 600A of FIG. 6A for communication with and transmit power level control of the other (e.g., refer to message flow 400B of FIG. 4B).

In method 500A of FIG. 5A, a first communication signal including a first message is received, at an act 502. A signal strength of the first communication signal is detected, at an act 504. A preamble having a preamble bit length is generated, at an act 506. In generating the preamble at act 506, the preamble bit length is adjusted at least partially based on the detected signal strength of the first communication signal. A second communication signal including a second message is transmitted, at an act 506. In the transmitting at act 508, the second message includes the preamble having the preamble bit length adjusted based on the detected signal strength.

In one or more examples, when the other transceiver transmits to the transceiver an initial communication signal(s) for receipt (e.g., the first communication signal including the first message, at act 502), the other transceiver transmits the initial communication signal at a maximum output power. That is, a transceiver may (e.g., always, or regularly) initiate transmissions of messages to the other transceiver at maximum output power (e.g., and subsequently be controlled to lower their respective transmit powers if beneficial).

As one example of act 506 of FIG. 5A, the detected signal strength is compared with one or more thresholds, and the preamble bit length of the preamble is adjusted based on a result of the comparing. As a specific, non-limiting example, at least partially based on the result of the comparing indicating that the detected signal strength is greater than a threshold, a preamble having a first preamble bit length is generated; and at least partially based on the result of the comparing indicating that the detected signal strength is less than the threshold, a preamble having a second preamble bit length is generated.

In one or more examples, the preamble having the preamble bit length is an instruction to another transceiver to adjust a transmit power level for transmission according to the preamble bit length. For example, at the other transceiver, the second communication signal including the second message having the preamble is received, and a transmit power level for transmission is adjusted at the other transceiver at least partially based on the preamble bit length of the preamble. The preamble is also used for synchronization at the other transceiver.

In one or more examples, the transceiver to perform method 500A of FIG. 5A additionally performs method 600A of FIG. 6A, which is discussed later below. In one or more examples, a preamble bit length of a preamble of the first message of the first communication signal is detected by the transceiver; and a transmit power level to transmit the second communication signal is adjusted by the transceiver at least partially based on the preamble bit length of the first message. For example, at least partially based on the preamble bit length comprising a first preamble bit length, the transmit power level to transmit the second communication signal is decreased; at least partially based on the preamble bit length comprising a second preamble bit length, the transmit power level to transmit the second communication signal is maintained (e.g., no change to the transmit power level); and at least partially based on the preamble bit length comprising a third preamble bit length, the transmit power level to transmit the second communication signal is increased.

In one or more examples, a predetermined adjustment amount is used for respective incremental adjustments associated with the received preambles. In one or more other examples, only two (e.g., coarse) adjustment settings associated with the respective lesser and greater preamble bit lengths are used for control (e.g., set transmit power level to lower setting, or set transmit power level to higher setting).

FIG. 5B is a flowchart of a more detailed method 500B of a first transceiver to control a transmit power level of a second transceiver according to preamble bit length of a preamble, according to one or more examples. Method 500B of FIG. 5B is substantially the same as method 500A of FIG. 5A, with act 502, act 504, and act 508 of method 500B being the same as in method 500A, and act 506 of method 500A being represented as one of an act 506a, an act 506b, and an act 506c of method 500B. In one or more examples, transceiver 102 (FIG. 1) operates to perform method 500B of FIG. 5B for communication with and transmit power level control of transceiver 104 (FIG. 1) which operates to perform a method 600B of FIG. 6B (e.g., refer to message flow 400A of FIG. 4A). In one or more specific examples, respective ones of transceiver 102 and transceiver 104 operate to perform both method 500B of FIG. 5B and method 600B of FIG. 6B for communication with and transmit power level control of each other (e.g., refer to message flow 400B of FIG. 4B).

In method 500B of FIG. 5B, the detected signal strength of the first communication signal is compared with one or more thresholds, at an act 505. At least partially based on a result of the comparing at act 505, the preamble bit length of the preamble is adjusted (e.g., according to one of act 506a, act 506b, and act 506c). More particularly, at least partially based on the result of the comparing at act 505 indicating that the detected signal strength is greater than a target threshold range (e.g., signal strength too high), the preamble having the preamble bit length comprising a first preamble bit length is generated, at act 506a. At least partially based on the result of the comparing at act 505 indicating that the detected signal strength is within the target threshold range (e.g., adequate or good signal strength), the preamble having the preamble bit length comprising a second preamble bit length is generated, at act 506b. At least partially based on the result of the comparing at act 505 indicating that the detected signal strength is less than the target threshold range (e.g., signal strength too low), the preamble having the preamble bit length comprising a third preamble bit length is generated, at an act 506c. In the transmitting at act 508, the second message of the second communication signal includes the preamble having the preamble bit length adjusted (e.g., according to one of act 506a, act 506b, and 506c) based on the detected signal strength.

In one or more examples, the preambles having the first preamble length, the second preamble length, and the third preamble length are generated to have the same pattern or sequence (e.g., alternating sequence of +1 and −1 values).

In one or more examples of method 500B, the second preamble bit length of the preamble of act 506b is A bits (e.g., preamble 302 of FIG. 3A), the first preamble bit length of the preamble of act 506a is one of (A−Z) bits or (A+Z) bits (e.g., (A−Z) bits, and/or preamble 302 of FIG. 3B), and the third preamble bit length of the preamble of act 506c is the other one of (A−Z) bits or (A+Z) bits (e.g., (A+Z) bits, and/or preamble 302 of FIG. 3C) (where A and Z are predetermined positive integer constants and A>Z). Here, in one or more specific examples, A bits=(X+Y) bits, where X is a predetermined preamble bit length of a preamble specified in a communication standard with which the transceiver is compatible, and Y>Z (where X and Y are predetermined positive integer constants).

In one or more alternative examples of method 500B, the second preamble bit length is X bits, the first preamble bit length is (X+J) bits, and the third preamble bit length is (X+K) bits, where X is a predetermined preamble bit length of a preamble specified in a communication standard with which the transceiver is compatible, and J≠K (where X, J, and K are predetermined positive integer constants).

FIG. 6A is a flowchart of a method 600A of a second transceiver to control a transmit power level according to preamble bit length of a preamble received from a first transceiver, according to one or more examples. Method 600A may be implemented in a transceiver of a communication device (e.g., transceiver 102 and/or transceiver 104 of FIG. 1). In one or more examples, acts of method 600A are implemented in a transceiver PHY (e.g., in PHY circuitry) for PHY-level control of the transmit power level. In one or more examples, transceiver 102 operates to perform method 600A of FIG. 6A for communication with and transmit power level control of transceiver 104 which operates to perform method 500A of FIG. 5A (e.g., refer to message flow 400A of FIG. 4A). In one or more specific examples, respective ones of transceiver 102 and transceiver 104 operate to perform both method 500A of FIG. 5A and method 600A of FIG. 6A for communication and transmit power level control with each other (e.g., refer to message flow 400B of FIG. 4B).

In method 600A of FIG. 6A, a first communication signal including a first message is received, at an act 602. Synchronization is performed using a preamble of the first message. A preamble bit length of a preamble of the first message is detected, at an act 604. A gain of a transmitter amplifier of the transceiver is adjusted at least partially based on the preamble bit length of the preamble, at an act 606. A second communication signal including a second message is amplified with the transmitter amplifier having the adjusted gain, at an act 608. The amplified second communication signal including the second message is transmitted, at an act 610.

As one example of act 606 of FIG. 6A, at least partially based on the preamble bit length comprising a first preamble bit length, the gain of the transmitter amplifier is decreased; and at least partially based on the preamble bit length comprising a second preamble bit length, the gain of the transmitter amplifier is increased.

In one or more examples, detecting the preamble bit length of the preamble at act 604 comprises maintaining a count of received bits of the preamble until a total count of the received bits of the preamble is reached. Here, in one or more examples, adjusting the gain of the transmitter amplifier at act 606 comprises adjusting the gain of the transmitter amplifier at least partially based on the total count of received bits of the preamble. In one or more specific examples, adjusting the gain of the transmitter amplifier at act 606 comprises incrementing or decrementing the gain control count for adjustment of the gain at least partially based on the total count of received bits of the preamble. In one or more further examples, the adjusting at act 606, the amplifying at act 608, and the transmitting at act 610 are repeated (e.g., regularly) at least partially based on respective ones of subsequently detected preamble bit lengths of subsequently received preambles.

In one or more examples, the transceiver to perform method 600A of FIG. 6A is to additionally perform method 500A of FIG. 5A, which was discussed earlier above. Here, in one or more examples, a signal strength of the first communication signal is detected; a preamble having a preamble bit length is generated, where the preamble bit length is adjusted at least partially based on the detected signal strength; and the amplified second communication signal which is transmitted at act 610 includes the second message with the preamble having the preamble bit length. In one or more examples, the detected signal strength is compared with one or more thresholds, and the preamble bit length of the preamble is adjusted based on a result of the comparing. As a specific, non-limiting example, at least partially based on the result of the comparing indicating that the detected signal strength is greater than a threshold, a preamble having a first preamble bit length is generated; and at least partially based on the result of the comparing indicating that the detected signal strength is less than the threshold, a preamble having a second preamble bit length is generated. In one or more examples, the preamble having the preamble bit length is an instruction to another transceiver to adjust a transmit power level for transmission according to the preamble bit length. For example, at the other transceiver, the second communication signal including the second message having the preamble is received, and a transmit power level for transmission is adjusted at the other transceiver at least partially based on the preamble bit length of the preamble.

In one or more examples, a predetermined adjustment amount is used for respective incremental adjustments associated with the received preambles. In one or more other examples, only two (e.g., coarse) adjustment settings associated with the respective lesser and greater preamble bit lengths are used for control (e.g., set transmit power level to lower setting, or set transmit power level to higher setting).

FIG. 6B is a flowchart of a more detailed method 600B of a second transceiver to control a transmit power level according to preamble bit length of a preamble received from a first transceiver, according to one or more examples. Method 600B may be implemented in a transceiver of a communication device (e.g., transceiver 102 and/or transceiver 104 of FIG. 1). In one or more examples, transceiver 102 (FIG. 1) operates to perform method 600B of FIG. 6B for communication with and transmit power level control of transceiver 104 (FIG. 1) which operates to perform method 500B of FIG. 5B (e.g., refer to message flow 400A of FIG. 4A). In one or more specific examples, respective ones of transceiver 102 and transceiver 104 operate to perform both method 500A of FIG. 5A and method 600A of FIG. 6A for communication with and transmit power level control of each other (e.g., refer to message flow 400B of FIG. 4B).

Method 600B of FIG. 6B is substantially the same as method 600A of FIG. 6A, with act 602, act 604, act 608, and act 610 of method 600B being the same as in method 600A, and act 606 of method 600A being represented as one of an act 606a, an act 606b, and an act 606c of method 600B.

In method 600B of FIG. 6B, the preamble bit length of the preamble is detected, at act 604. At least partially based on the preamble bit length comprising a first preamble bit length at act 604, the gain of the transmitter amplifier to transmit the second communication signal is decreased, at act 606a. At least partially based on the preamble bit length comprising a second preamble bit length at act 604, the gain of the transmitter amplifier to transmit the second communication signal is maintained (e.g., no change to the gain), at act 606b. At least partially based on the preamble bit length comprising a third preamble bit length at act 604, the gain of the transmitter amplifier to transmit the second communication signal is increased, at act 606c. The amplified second communication signal including the second message is transmitted, at act 610.

In one or more examples, the preambles having the first preamble length, the second preamble length, and the third preamble length are generated to have the same pattern or sequence (e.g., alternating sequence of +1 and −1 values).

In one or more examples of method 600B, the second preamble bit length of the preamble of act 606b is A bits (e.g., preamble 302 of FIG. 3A), the first preamble bit length of the preamble of act 606a is one of (A−Z) bits or (A+Z) bits (e.g., (A−Z) bits, and/or preamble 302 of FIG. 3B), and the third preamble bit length of the preamble of act 606c is the other one of (A−Z) bits or (A+Z) bits (e.g., (A+Z) bits, and/or preamble 302 of FIG. 3C) (where A and Z are predetermined positive integer constants and A>Z). Here, in one or more specific examples, A bits=(X+Y) bits, where X is a predetermined preamble bit length of a preamble specified in a communication standard with which the transceiver is compatible, and Y>Z (where X and Y are predetermined positive integer constants).

In one or more alternative examples of method 600B, the second preamble bit length is X bits, the first preamble bit length is (X+J) bits, and the third preamble bit length is (X+K) bits, where X is a predetermined preamble bit length of a preamble specified in a communication standard with which the transceiver is compatible, X, J, and K are predetermined positive integer constants, and J≠K.

FIG. 7 is a block diagram of a communication device 700 including a transceiver PHY 704, according to one or more examples. In one or more examples, the architecture of communication device 700 of FIG. 7 may be included in respective ones of the first communication device including transceiver 102 of FIG. 1 and the second communication device including transceiver 104 of FIG. 1.

Communication device 700 of FIG. 7 includes an application layer processing circuitry 702, transceiver PHY 704, and an analog front-end (AFE) 706. Application layer processing circuitry 702 includes an application receive processing module 710 and an application send processing module 712. Application layer processing circuitry 702 may be implemented using one or more processors, such as one or more microcontrollers, microprocessors, and so on, for processing. Transceiver PHY 704 includes a receiver PHY 714, a transmitter PHY 716, and a control circuitry 718 operably coupled to receiver PHY 714 and transmitter PHY 716. AFE 720 includes a receiver AFE circuitry 720 and a transmitter AFE circuitry 722.

For receive processing, wireless communication signals are received and processed at receiver AFE circuitry 720, and routed to and processed at receiver PHY 714, where data signals are passed to and processed at application receive processing module 710. For transmit processing, data signals from application send processing module 712 are passed to and processed at transmitter PHY 716, and routed to and processed at transmitter AFE circuitry 722 for transmission of the wireless communication signals.

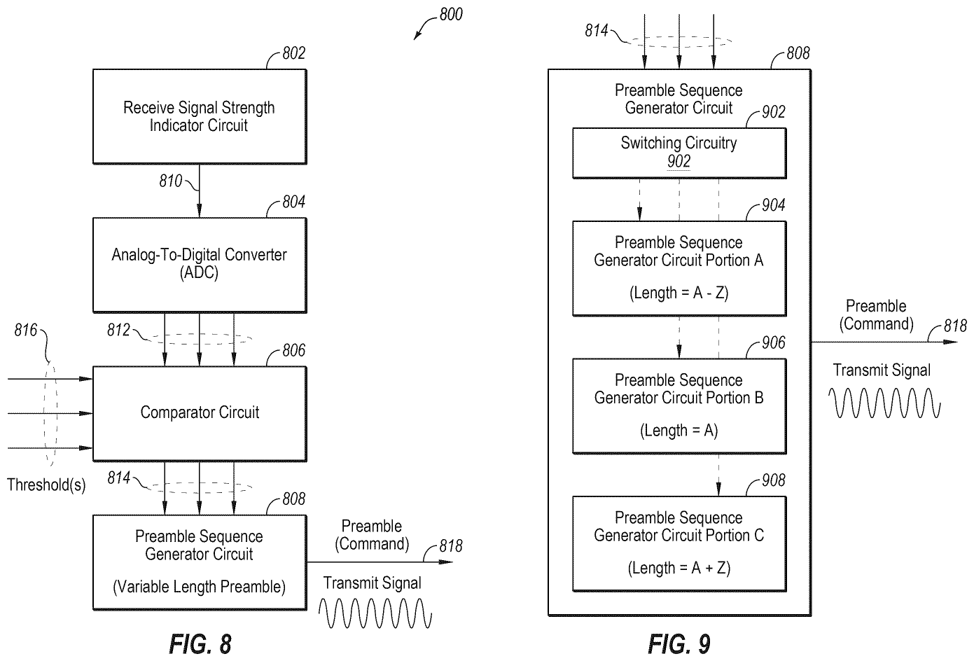

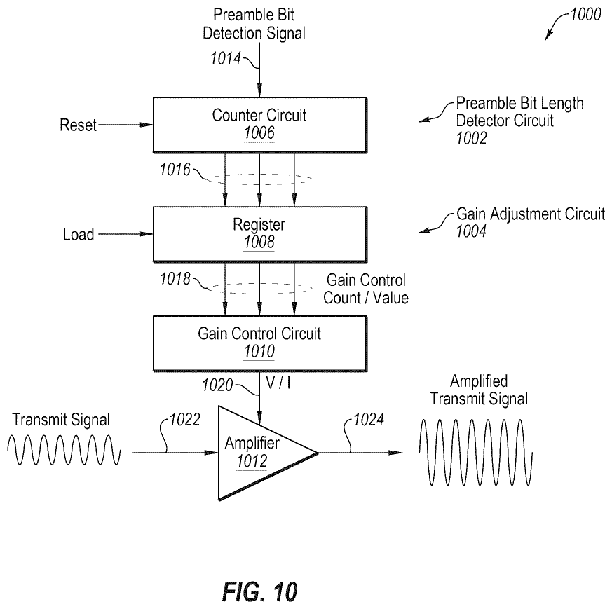

In one or more examples, transceiver PHY 704 includes any one of the electronic circuitries of FIGS. 8, 9, 10, 11, and 12, or combinations thereof, which are discussed in detail below. As one or more examples, receiver PHY 714 of FIG. 7 with or without control circuitry 718 may include electronic circuitry of FIG. 8 and/or FIG. 9; and/or transmitter PHY 716 of FIG. 7 with or without control circuitry 718 may include electronic circuitry of FIG. 10, 11, or 12).

FIG. 8 is a schematic block diagram of an electronic circuitry 800 in a transceiver (e.g., a transceiver PHY) for controlling a transmit power level according to preamble bit length, according to one or more examples. In one or more examples, electronic circuitry 800 implements method 500A of FIG. 5A or method 500B of FIG. 5B.

Electronic circuitry 800 includes a receive signal strength indicator circuit 802, an analog-to-digital converter (ADC) 804, a comparator circuit 806, and a preamble sequence generator circuit 808. Received signal strength indicator circuit 802 detects a signal strength of a first communication signal including a first message. In one or more examples, receive signal strength indicator circuit 802 produces, at an output 810, a receive signal strength indicator (RSSI) of the first communication signal. The receive signal strength indicator at output 810 is provided as an analog signal to an input of ADC 804. ADC 804 converts an analog value of the detected signal strength to binary signal values provided at outputs 812, and provides the binary signal values to inputs to comparator circuit 806.

Comparator circuit 806 compares the detected signal strength (e.g., the binary signal values) of the first communication signal with one or more thresholds at inputs 816. One or more outputs 814 of comparator circuit 806 are coupled to preamble sequence generator circuit 808. Preamble sequence generator circuit 808 generates a preamble at an output 818. Preamble sequence generator circuit 808 adjusts a preamble bit length of the preamble at least partially based on one or more outputs 814 of comparator circuit 806. In one or more examples, the preamble may be considered to be a variable bit length preamble, which is adjusted according to the detected signal strength or RSSI. The preamble is included in a second message carried by a second communication signal for transmission.

In one or more examples, preamble sequence generator circuit 808 generates a preamble having a first preamble bit length at least partially based on one or more outputs 814 of comparator circuit 806 indicating that the detected signal strength is greater than a threshold, and generates a preamble having a second preamble bit length at least partially based on one or more outputs 814 of comparator circuit 806 indicating that the detected signal strength is less than the threshold.

In one or more specific examples, preamble sequence generator circuit 808 generates a preamble having a first preamble bit length at least partially based on one or more outputs 814 of comparator circuit 806 indicating the detected signal strength is greater than a target threshold range (e.g., signal strength too high), generates a preamble having a second preamble bit length at least partially based on one or more outputs 814 of comparator circuit 806 indicating the detected signal strength is within the target threshold range (e.g., adequate or good signal strength), and generates a preamble having a third preamble bit length at least partially based on one or more outputs 814 of comparator circuit 806 indicating the detected signal strength is less than the target threshold range (e.g., signal strength too low).

In one or more examples, the second preamble bit length is A bits (e.g., preamble 302 of FIG. 3A), the first preamble bit length is one of (A−Z) bits or (A+Z) bits (e.g., (A−Z) bits, and/or preamble 304 of FIG. 3B), and the third preamble bit length is the other one of (A−Z) bits or (A+Z) bits (e.g., (A+Z) bits, and/or preamble 306 of FIG. 3C). Here, in one or more specific examples, A bits=(X+Y) bits, where X is a predetermined preamble bit length of a preamble specified in a communication standard with which the transceiver is compatible, and Y>Z (where X and Y are predetermined positive integer constants).

In one or more alternative examples, the second preamble bit length is X bits, the first preamble bit length is (X+J) bits, and the third preamble bit length is (X+K) bits, where X is a predetermined preamble bit length of a preamble specified in a communication standard with which the transceiver is compatible, and J≠K (where X, J, and K are predetermined positive integer constants).

With reference to one or more examples of FIG. 9, preamble sequence generator circuit 808 may include a switching circuitry 902 and a number of preamble sequence generator circuit portions 904, 906, and 908. Respective ones of preamble sequence generator circuit portions 904, 906, and 908 may be selectively enabled to generate preamble sequences having different preamble bit lengths. As one example, preamble sequence generator circuit portion 904 may generate a preamble having a first preamble bit length (e.g., (A−Z) bits), preamble sequence generator circuit portion 906 may generate a preamble having a second preamble bit length (e.g., A bits), and preamble sequence generator circuit portion 908 may generate a preamble having a third preamble bit length (e.g., (A+Z) bits). In one or more examples, switching circuitry 902 may switchably enable or activate a respective one of preamble sequence generator circuit portions 904, 906, and 908 based on one or more outputs 814 of comparator circuit 806 to generate the preamble having the desired preamble length.

As another example, preamble sequence generator circuit portion 904 may generate a preamble having a first preamble bit length (e.g., (A−Z) bits), preamble sequence generator circuit portion 906 may continue generation of the preamble to have a second preamble bit length (e.g., A bits), and preamble sequence generator circuit portion 908 may further continue generation of the preamble to have a third preamble bit length (e.g., (A+Z) bits). Here, in one or more examples, switching circuitry 902 switchably may enable or activate respective ones of preamble sequence generator circuit portions 904, 906, and 908 based on one or more outputs 814 of comparator circuit 806 to generate the preamble with the desired preamble length.

FIG. 10 is a schematic block diagram of an electronic circuitry 1000 in a transceiver (e.g., a transceiver PHY) for controlling a transmit power level according to preamble bit length, according to one or more examples. In one or more examples, electronic circuitry 1000 implements method 600A of FIG. 6A or method 600B of FIG. 6B. In one or more examples, the gain of transmitter amplifier 1012 is set at a maximum output power when an initial communication signal is transmitted from the transceiver.

Electronic circuitry 1000 includes a preamble bit length detector circuit 1002, a gain adjustment circuit 1004, and a transmitter amplifier 1012. In one or more examples of FIG. 10, preamble bit length detector circuit 1002 includes a counter circuit 1006 and a register 1008, and gain adjustment circuit includes a gain control circuit 1010. In general, preamble bit length detector circuit 1002 is to detect a preamble bit length of a preamble of a first message of a first communication signal. Gain adjustment circuit 1004 is to adjust a gain of the transmitter amplifier 1012 at least partially based on the detected preamble bit length. Transmitter amplifier 1012 is to amplify, using the adjusted gain, a second communication signal including a second message for transmission.

Providing more detail, counter circuit 1006 of preamble bit length detector circuit 1002 maintains a count of received bits of the preamble until reaching a total count of received bits of the preamble. For example, an input 1014 of counter circuit 1006 may receive a preamble bit detection signal for respective ones of detected preamble bits of the preamble sequence, thereby incrementing or decrementing the count of counter circuit 1006 which is provided at outputs 1016. When the total count of received bits of the preamble is reached at counter circuit 1006 (e.g., indicated by SFD detection and/or other), the total count of the preamble from counter circuit 1006 is loaded into register 1008 (via a load signal at register 1008). The total count is provided as a gain control count at outputs 1018 of register 1008. Gain control circuit 1010 converts the gain control count from register 1008 to an analog signal or digital binary signal values representing the (adjusted) gain at one or more outputs 1020. Transmitter amplifier 1012 amplifies, using the adjusted gain, a transmit signal at an input 1022 to generate an amplified transmit signal at an output 1024.

In one or more examples, the gain of transmitter amplifier 1012 may be repeatedly adjusted (e.g., regularly) in the same or similar manner as described according to respective ones of subsequently detected preamble bit lengths of subsequently received preambles, where counter circuit 1006 is reset (via a reset signal at counter circuit 1006) after respective preamble detections and register 1008 is loaded with new total count values of respective newly received preambles.

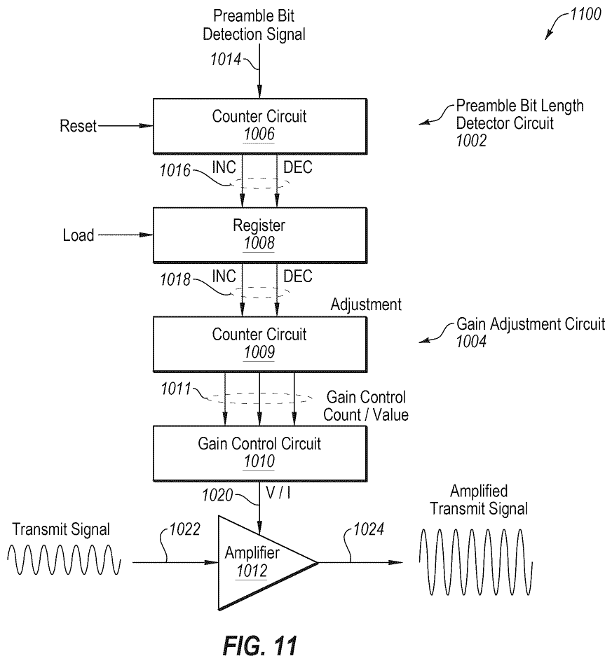

FIG. 11 is a schematic block diagram of an electronic circuitry 1100 in a transceiver (e.g., a transceiver PHY) for controlling a transmit power level according to preamble bit length, according to one or more examples. In one or more examples, electronic circuitry 1100 implements method 600A of FIG. 6A or method 600B of FIG. 6B.

Electronic circuitry 1100 of FIG. 11 is substantially the same as electronic circuitry 1000 of FIG. 10, where the same or similar components or elements operating in the same or similar manner retain the same numbering in the figures. In FIG. 11, gain adjustment circuit 1004 further includes a counter circuit 1009 with gain control circuit 1010. In FIG. 11, counter circuit 1009 of gain adjustment circuit 1004 maintains a separate gain control count (i.e., separate from the total count from counter circuit 1006 and/or register 1008) at one or more outputs 1011 for adjustment of the gain. Counter circuit 1009 increments or decrements the gain control count at one or more outputs 1011 at least partially based on the total count of received preamble bits from counter circuit 1006 and/or register 1008. The gain control count at one or more outputs 1011 of counter circuit 1009 is provided to gain control circuit 1010 for adjustment of the gain of transmitter amplifier 1012. The gain control count at counter circuit 1009 may be maintained, incremented, or decremented from preamble to preamble (e.g., counter circuit 1009 is not reset from preamble to preamble).

In one or more examples, when an initial communication signal(s) is to be transmitted from the transceiver to the other transceiver, counter circuit 1009 and/or register 1008 may be initialized or loaded with a gain control count comprising a maximum gain control count corresponding to a maximum gain (i.e., for a maximum output power) to be provided to transmitter amplifier 1012 from gain control circuit 1010.

In one or more alternative examples, counter circuit 1006 provides, at outputs 1016, an increment signal output to assert an increment signal (e.g., a binary signal value, where 1=increment) and a decrement signal output to assert a decrement signal (e.g., using another binary signal value, where 1=decrement), rather than providing the entire total count of received preamble bits. No signal is asserted in order to maintain the current gain control count. When the total count of received bits of the preamble is reached (e.g., indicated by SFD detection and/or other), one of the binary signal values (e.g., the increment signal or decrement signal) is loaded into register 1008 (via a load signal at register 1008), which is thereafter provided at outputs 1018 of register 1008 for adjustment to counter circuit 1009. For example, the increment signal output and the decrement signal output may be taken from a limited selection of outputs 1016 from counter circuit 1006 (e.g., selected outputs associated with only the leftmost or higher-order bits of the total count).

In one or more examples, the gain of transmitter amplifier 1012 may be repeatedly adjusted (e.g., regularly) in the same or similar manner as described based on respective ones of subsequently detected preamble bit lengths of subsequently received preambles, where counter circuit 1006 is reset (via a reset signal at counter circuit 1006) after respective preamble detections and register 1008 is loaded with new total count values (or increment/decrement signals) for respective newly received preambles. Here, the gain control count at counter circuit 1009 may be maintained, incremented, or decremented from preamble to preamble (e.g., counter circuit 1009 is not reset from preamble to preamble).

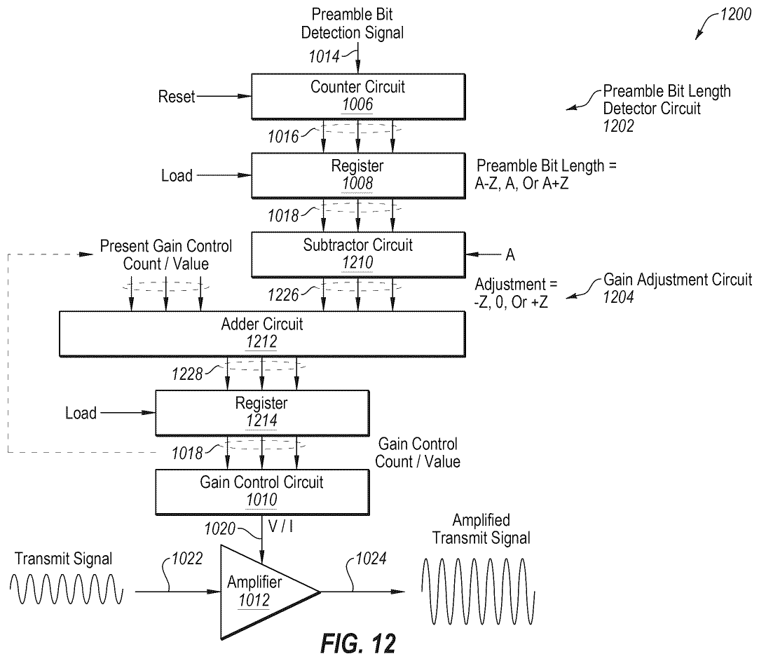

FIG. 12 is a schematic block diagram of an electronic circuitry 1200 in a transceiver (e.g., a transceiver PHY) for controlling a transmit power level according to preamble bit length, according to one or more examples. In one or more examples of FIG. 12, electronic circuitry 1200 implements method 600B of FIG. 6B.

Electronic circuitry 1200 of FIG. 12 is substantially the same as electronic circuitry 1000 of FIG. 10 and/or electronic circuitry 1100 of FIG. 11, where the same or similar components or elements operating in the same or similar manner retain the same numbering in the figures. In FIG. 12, electronic circuitry 1200 includes a preamble bit length detector circuit 1202 including counter circuit 1006, register 1008, and a subtractor circuit 1210, and a gain adjustment circuit 1204 including an adder circuit 1212, a register 1214, and gain control circuit 1010.

In preamble bit length detector circuit 1202, a total count of preamble bits is provided at outputs 1018 of register 1008 to subtractor circuit 1210. The total count may be one of preamble length (A−Z), preamble length A, or preamble length (A+Z) (e.g., FIGS. 3A, 3B, and 3C). Subtractor circuit 1210 subtracts the value “A” from the total count, and provides the result at outputs 1226. The result at outputs 1226 is an adjustment value which is equal to one of −Z, 0, or +Z (e.g., where the negative of −Z may be indicated at one of the outputs). In gain adjustment circuit 1204, adder circuit 1212 receives and adds the adjustment value to the present gain control count (provided from outputs 1018 of register 1214), the result of which is provided at outputs 1228. When the result from adder circuit 1212 is ready, the result is loaded into register 1214 (via a load signal at register 1214). The result provided at outputs 1018 of register 1214 is the newly adjusted gain control count of gain control circuit 1010 for adjustment of the gain of transmitter amplifier 1012.

In one or more examples, when an initial communication signal(s) is to be transmitted from the transceiver to the other transceiver, adder circuit 1212 and/or register 1214 may be initialized or loaded with a gain control count comprising a maximum gain control count corresponding to a maximum gain to be provided to transmitter amplifier 1012 from gain control circuit 1010.

In one or more examples, the gain of transmitter amplifier 1012 may be repeatedly adjusted (e.g., regularly) in the same or similar manner as described based on respective ones of subsequently detected preamble bit lengths of subsequently received preambles, where counter circuit 1006 is reset (via a reset signal at counter circuit 1006) after respective preamble detections, register 1008 is loaded with new total count values (or increment/decrement signals) for respective newly received preambles, and adder circuit 1212 and register 1214 are used to adjust and maintain the gain control count. Here, the gain control count at adder circuit 1212/register 1214 may be maintained, incremented, or decremented from preamble to preamble.

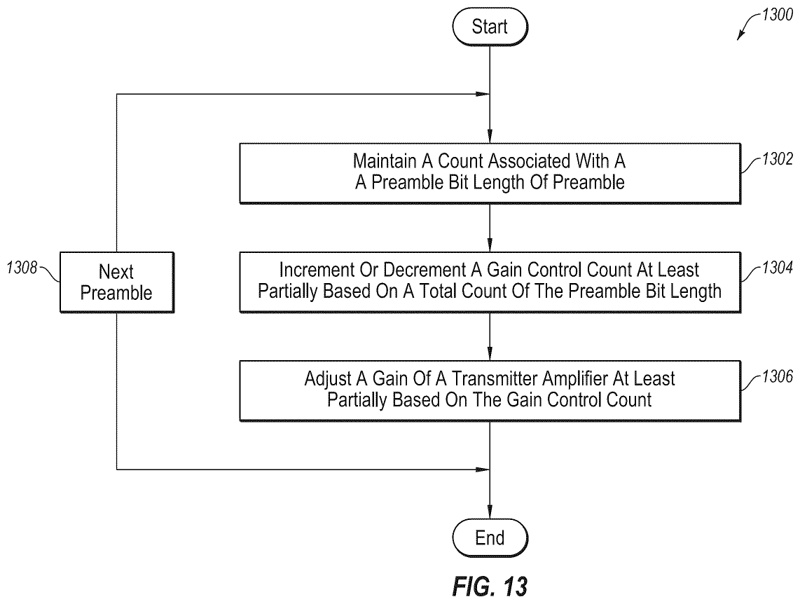

FIG. 13 is a flowchart of a method 1300 of controlling a transmit power level according to preamble bit length using one or more counter circuits, according to one or more examples. Method 1300 may be implemented in a transceiver of a communication device (e.g., transceiver 102 and/or transceiver 104 of FIG. 1). In one or more examples, acts of method 1300 are implemented in a transceiver PHY (e.g., in PHY circuitry) for PHY-level control of the transmit power level. In one or more examples, acts of method 1300 may be implemented in an electronic circuitry of a transceiver PHY, such as electronic circuitry 1100 of FIG. 11 or electronic circuitry 1200 of FIG. 12.

In method 1300 of FIG. 13, a count associated with a preamble bit length of a preamble is maintained, at an act 1302. A gain control count is incremented or decremented (e.g., or maintained) at least partially based on a total count associated with the preamble bit length, at an act 1304. A gain of a transmitter amplifier is adjusted at least partially based on the gain control count, at an act 1306. The transmitter amplifier may amplify, using the adjusted gain, a communication signal to generate an amplified communication signal for transmission. In one or more examples, the gain of the transmitter amplifier may be repeatedly adjusted (e.g., regularly) in the same or similar manner (e.g., repeating acts 1302, 1304, and 1306) based on respective ones of subsequently detected preamble bit lengths of subsequently received preambles (e.g., for a next preamble received at act 1308). In one or more examples, a predetermined adjustment amount is used for respective incremental adjustments associated with received preambles.

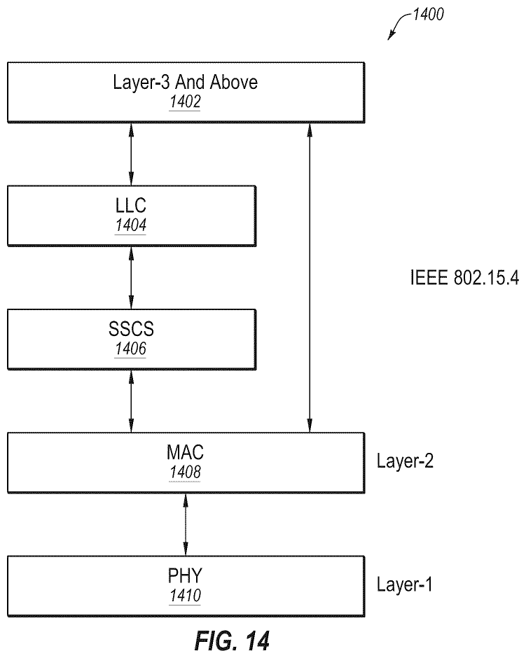

FIG. 14 is a protocol stack 1400 associated with an Institute of Electrical and Electronics Engineers (IEEE) 802.15.4 standard for low-rate wireless personal area networks (LR-WPANs). Protocol stack 1400 associated with the IEEE 802.15.4 standard includes a layer 3 and above layers 1402, a logical link control (LLC) sublayer 1404, a service specific convergence sublayer (SSCS) 1406, a medium access control (MAC) layer 1408 (or layer −2), and a physical (PHY) layer 1410 (or layer −1). In IEEE 802.15.4, the predetermined bit sequence of the preamble is a 16-bit sequence of alternating +1 and −1 values, and variations of this preamble bit length for transmit power level control are described herein (e.g., FIGS. 3B, 3C, and 3D). In one or more examples, methods and apparatuses including electronic circuitry (e.g., method 500A of FIG. 5A, method 500B of FIG. 5B, method 600A of FIG. 6A, method 600B of FIG. 6B, and/or method 1300 of FIG. 13, and electronic circuitry 800 of FIG. 8, electronic circuitry 1000 of FIG. 10, electronic circuitry 1100 of FIG. 11, and/or electronic circuitry 1200 of FIG. 12) are implemented in PHY layer 1410 of protocol stack 1400 for IEEE 802.15.4. In one or more alternative examples, variations of the preamble length for transmit power level control may be applied in relation to other communication standards, such as Bluetooth, Wi-Fi, SubGHz, and so on.

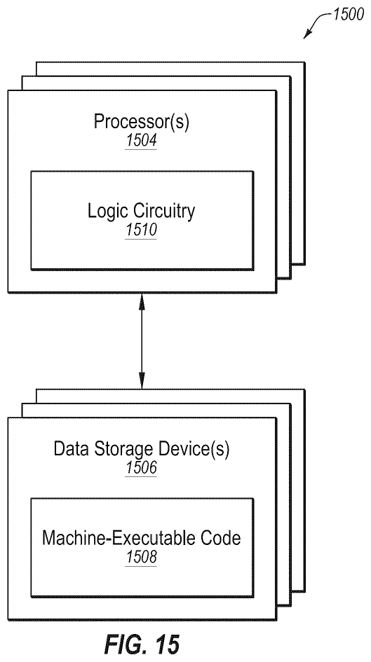

FIG. 15 is a block diagram of circuitry 1500 that, in some examples, may be used to implement various functions, operations, acts, processes, and/or methods disclosed herein. The circuitry 1500 includes one or more processors 1504 (sometimes referred to herein as “processors 1504”) operably coupled to one or more data storage devices (sometimes referred to herein as “storage 1506”). The storage 1506 includes machine-executable code 1508 stored thereon and the processors 1504 include a logic circuitry 1510. The machine-executable code 1508 includes information describing functional elements that may be implemented by (e.g., performed by) the logic circuitry 1510. The logic circuitry 1510 is adapted to implement (e.g., perform) the functional elements described by the machine-executable code 1508. The circuitry 1500, when executing the functional elements described by the machine-executable code 1508, should be considered as special purpose hardware for carrying out functional elements disclosed herein. In some examples, the processors 1504 may perform the functional elements described by the machine-executable code 1508 sequentially, concurrently (e.g., on one or more different hardware platforms), or in one or more parallel process streams.

When implemented by logic circuitry 1510 of the processors 1504, the machine-executable code 1508 adapts the processors 1504 to perform operations of examples disclosed herein. For example, the machine-executable code 1508 may be to adapt the processors 1504 to perform at least a portion or a totality of methods or processes described herein (e.g., methods or processes associated with application receive processing module 710 and application send processing module 712 of FIG. 7, and/or methods or processes associated with layer −3 and above layers 1402 of FIG. 14).

The processors 1504 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 1508 (e.g., software code, firmware code, hardware descriptions) related to examples of the present disclosure. It is noted that a general-purpose processor (may also be referred to herein as a host processor or simply a host) may be a microprocessor, but in the alternative, the processors 1504 may include any conventional processor, controller, microcontroller, or state machine. The processors 1504 may also be implemented as a combination of computing devices, such as a combination of a DSP and a microprocessor, a plurality of microprocessors, one or more microprocessors in conjunction with a DSP core, or any other such configuration.

In some examples the storage 1506 includes volatile data storage (e.g., random-access memory (RAM)), non-volatile data storage (e.g., Flash memory, a hard disc drive, a solid-state drive, erasable programmable read-only memory (EPROM), etc.). In some examples the processors 1504 and the storage 1506 may be implemented into a single device (e.g., a semiconductor device product, a system on chip (SOC), etc.). In some examples the processors 1504 and the storage 1506 may be implemented into separate devices.

In some examples the machine-executable code 1508 may include computer-readable instructions (e.g., software code, firmware code). By way of non-limiting example, the computer-readable instructions may be stored by the storage 1506, accessed directly by the processors 1504, and executed by the processors 1504 using at least the logic circuitry 1510. Also by way of non-limiting example, the computer-readable instructions may be stored on the storage 1506, transferred to a memory device (not shown) for execution, and executed by the processors 1504 using at least the logic circuitry 1510. Accordingly, in some examples the logic circuitry 1510 includes electrically configurable logic circuitry 1510.

In some examples the machine-executable code 1508 may describe hardware (e.g., circuitry) to be implemented in the logic circuitry 1510 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large-scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuitries (e.g., gates, flip-flops, registers, without limitation) of the logic circuitry 1510 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1508 may include an HDL, an RTL, a GL description, a mask level description, other hardware description, or any combination thereof.

In examples where the machine-executable code 1508 includes a hardware description (at any level of abstraction), a system (not shown, but including the storage 1506) may be to implement the hardware description described by the machine-executable code 1508. By way of non-limiting example, the processors 1504 may include a programmable logic device (e.g., an FPGA or a PLC) and the logic circuitry 1510 may be electrically controlled to implement circuitry corresponding to the hardware description into the logic circuitry 1510. Also by way of non-limiting example, the logic circuitry 1510 may include hard-wired logic manufactured by a manufacturing system (not shown, but including the storage 1506) according to the hardware description of the machine-executable code 1508.

Regardless of whether the machine-executable code 1508 includes computer-readable instructions or a hardware description, the logic circuitry 1510 is adapted to perform the functional elements described by the machine-executable code 1508 when implementing the functional elements of the machine-executable code 1508. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Not each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Example 1: A method comprising: at a transceiver, receiving a first communication signal including a first message; detecting a signal strength of the first communication signal; generating a preamble having a preamble bit length that is adjusted at least partially based on the detected signal strength of the first communication signal; and transmitting a second communication signal including a second message, the second message including the preamble having the preamble bit length.

Example 2: The method according to Example 1, comprising: at the transceiver, comparing the detected signal strength with one or more thresholds, wherein the preamble bit length of the preamble is adjusted at least partially based on a result of the comparing.

Example 3: The method according to any of Examples 1 and 2, comprising: at the transceiver, at least partially based on the result of the comparing indicating that the detected signal strength is greater than a threshold, generating the preamble having the preamble bit length comprising a first preamble bit length; and at least partially based on the result of the comparing indicating that the detected signal strength is less than the threshold, generating the preamble having the preamble bit length comprising a second preamble bit length.

Example 4: The method according to any of Examples 1 through 3, comprising: at the transceiver, at least partially based on the result of the comparing indicating that the detected signal strength is greater than a target threshold range, generating the preamble having the preamble bit length comprising a first preamble bit length, the target threshold range defined by the one or more thresholds; at least partially based on the result of the comparing indicating that the detected signal strength is within the target threshold range, generating the preamble having the preamble bit length comprising a second preamble bit length; and at least partially based on the result of the comparing indicating that the detected signal strength is less than the target threshold range, generating the preamble having the preamble bit length comprising a third preamble bit length.

Example 5: The method according to any of Examples 1 through 4, wherein: the second preamble bit length is A bits, the first preamble bit length is one of (A−Z) bits or (A+Z) bits, the third preamble bit length is the other one of (A−Z) bits or (A+Z) bits, and where A and Z are predetermined positive integer constants, and A>Z.

Example 6: The method according to any of Examples 1 through 5, wherein: A bits=(X+Y) bits, and where X and Y are predetermined positive integer constants, X is a predetermined preamble bit length of a preamble specified in a communication standard with which the transceiver is compatible, and Y>Z.

Example 7: The method according to any of Examples 1 through 6, wherein: the second preamble bit length is X bits, the first preamble bit length is (X+J) bits, the third preamble bit length is (X+K) bits, and where X, J, and K are predetermined positive integer constants, X is a predetermined preamble bit length of a preamble specified in a communication standard with which the transceiver is compatible, and J≠K.

Example 8: The method according to any of Examples 1 through 7, comprising: at the transceiver, detecting a preamble bit length of a preamble of the first message of the first communication signal; and adjusting a transmit power level to transmit the second communication signal at least partially based on the preamble bit length of the first message.

Example 9: The method according to any of Examples 1 through 8, comprising: at the transceiver, detecting a preamble bit length of a preamble of the first message of the first communication signal; at least partially based on the preamble bit length comprising a first preamble bit length, decreasing the transmit power level to transmit the second communication signal; at least partially based on the preamble bit length comprising a second preamble bit length, maintain the transmit power level to transmit the second communication signal; and at least partially based on the preamble bit length comprising a third preamble bit length, increasing the transmit power level to transmit the second communication signal.

Example 10: The method according to any of Examples 1 through 9, wherein the preamble having the preamble bit length comprises an instruction to another transceiver to adjust a transmit power level for transmission according to the preamble bit length.

Example 11: An apparatus comprising: a transceiver including: a received signal strength indicator circuit to detect a signal strength of a first communication signal including a first message; a comparator circuit to compare the detected signal strength of the first communication signal with one or more thresholds; and a preamble sequence generator circuit to generate a preamble of a second message of a second communication signal for transmission, the preamble sequence generator circuit to adjustably set a preamble bit length of the preamble at least partially based on one or more outputs of the comparator circuit.

Example 12: The apparatus according to Example 11, wherein: the preamble sequence generator circuit to: generate the preamble having the preamble bit length comprising a first preamble bit length at least partially based on the one or more outputs of the comparator circuit indicating that the detected signal strength is greater than a threshold; and generate the preamble having the preamble bit length comprising a second preamble bit length at least partially based on the one or more outputs of the comparator circuit indicating that the detected signal strength is less than the threshold.

Example 13: The apparatus according to any of Examples 11 and 12, wherein: the preamble sequence generator circuit to: generate the preamble having the preamble bit length comprising a first preamble bit length at least partially based on the one or more outputs of the comparator circuit indicating the detected signal strength is greater than a target threshold range, the target threshold range defined by the one or more thresholds; generate the preamble having the preamble bit length comprising a second preamble bit length at least partially based on to the one or more outputs of the comparator circuit indicating the detected signal strength is within the target threshold range; and generate the preamble having the preamble bit length comprising a third preamble bit length at least partially based on the one or more outputs of the comparator circuit indicating the detected signal strength is less than the target threshold range.

Example 14: The apparatus according to any of Examples 11 through 13, wherein: the second preamble bit length is A bits, the first preamble bit length is one of (A−Z) bits or (A+Z) bits, the third preamble bit length is the other one of (A−Z) bits or (A+Z) bits, and where A and Z are predetermined positive integer constants, where A>Z.

Example 15: The apparatus according to any of Examples 11 through 14, wherein the transceiver comprises a transceiver PHY including the receiver signal strength indicator circuit, the comparator circuit, and the preamble sequence generator circuit, the apparatus comprising: an analog-to-digital converter to convert an analog value of the detected signal strength to a digital value, the analog-to-digital converter to provide the digital value of the detected signal strength to an input of the comparator circuit.

Example 16: The apparatus according to any of Examples 11 through 15, wherein: the transceiver including: a preamble bit length detector circuit to detect a preamble bit length of a preamble of the first message of the first communication signal; a transmitter amplifier; a gain adjustment circuit to adjust a gain of the transmitter amplifier at least partially based on the detected preamble bit length; and the transmitter amplifier to amplify, with the adjusted gain, a second communication signal including a second message for transmission.

Example 17: The apparatus according to any of Examples 11 through 16, wherein: the gain adjustment circuit to decrease the gain of the transmitter amplifier at least partially based on the preamble bit length comprising a first preamble bit length, the gain adjustment circuit to increase the gain of the transmitter amplifier at least partially based on the preamble bit length comprising a second preamble bit length.

Example 18: The apparatus according to any of Examples 11 through 17, wherein: the preamble bit length detector circuit includes a first counter circuit to maintain a count of received bits of the preamble to reach a total count of received bits of the preamble, and the gain adjustment circuit includes a second counter circuit to maintain a gain control count for adjustment of the gain of the transmitter amplifier, the second counter circuit to increment or decrement the gain control count at least partially based on the total count of received bits of the preamble from the first counter circuit.

Example 19: A method comprising: at a transceiver, receiving a first communication signal including a first message; detecting a preamble bit length of a preamble of the first message; adjusting a gain of a transmitter amplifier of the transceiver at least partially based on the preamble bit length of the preamble; amplifying, with the transmitter amplifier having the adjusted gain, a second communication signal including a second message; and transmitting the amplified second communication signal including the second message.

Example 20: The method according to Example 19, comprising: at the transceiver, at least partially based on the preamble bit length comprising a first preamble bit length, decreasing the gain of the transmitter amplifier to transmit the amplified second communication signal; and at least partially based on the preamble bit length comprising a second preamble bit length, increasing the gain of the transmitter amplifier to transmit the amplified second communication signal.

Example 21: The method according to any of Examples 19 and 20, comprising: at the transceiver, at least partially based on the preamble bit length comprising a first preamble bit length, decreasing the gain of the transmitter amplifier to transmit the amplified second communication signal; at least partially based on the preamble bit length comprising a second preamble bit length, maintaining the gain of the transmitter amplifier to transmit the amplified second communication signal; and at least partially based on the preamble bit length comprising a third preamble bit length, increasing the gain of the transmitter amplifier to transmit the amplified second communication signal.

Example 22: The method according to any of Examples 19 through 21, wherein: the second preamble bit length is A bits, the first preamble bit length is one of (A−Z) bits or (A+Z) bits, the third preamble bit length is the other one of (A−Z) bits or (A+Z) bits, and where A and Z are predetermined positive integer constants, where A>Z.

Example 23: The method according to any of Examples 19 through 22, wherein: detecting the preamble bit length of the preamble comprises maintaining a count of received bits of the preamble to reach a total count of the received bits of the preamble, and adjusting the gain of the transmitter amplifier comprises adjusting the gain of the transmitter amplifier at least partially based on the total count of received bits of the preamble.

Example 24: The method according to any of Examples 19 through 23, wherein: detecting the preamble bit length of the preamble comprises maintaining a count of received bits of the preamble to reach a total count of received bits of the preamble, adjusting the gain of the transmitter amplifier comprises incrementing or decrementing a gain control count for adjustment of the gain at least partially based on the total count of received bits of the preamble, and repeating the adjusting, the amplifying, and the transmitting at least partially based on respective ones of subsequently detected preamble bit lengths of subsequently received preambles.

Example 25: The method according to any of Examples 19 through 24, comprising: at the transceiver, detecting a signal strength of the first communication signal; and generating a preamble having a preamble bit length that is adjusted at least partially based on the detected signal strength, wherein transmitting the amplified second communication signal comprises transmitting the amplified second communication signal including the second message with the preamble having the preamble bit length.

Example 26: The method according to any of Examples 19 through 25, comprising: at the transceiver, comparing the detected signal strength with one or more thresholds, wherein the preamble bit length of the preamble of the second message is adjusted at least partially based on a result of the comparing.

Example 27: The method according to any of Examples 19 through 26, comprising: at the transceiver, at least partially based on the result of the comparing indicating that the detected signal strength is greater than a target threshold range, generating the preamble having the preamble bit length comprising a first preamble bit length, the target threshold range defined by the one or more thresholds; at least partially based on the result of the comparing indicating that the detected signal strength is within the target threshold range, generating the preamble having the preamble bit length comprising a second preamble bit length; and at least partially based on the result of the comparing indicating that the detected signal strength is less than the target threshold range, generating the preamble having the preamble bit length comprising a third preamble bit length.

Example 28: The method according to any of Examples 19 through 27, wherein the preamble having the preamble bit length in the second message comprises an instruction to another transceiver to adjust a transmit power level for transmission according to the preamble bit length.

Example 29: The method according to any of Examples 19 through 28, comprising: at another transceiver, receiving the second communication signal including the second message having the preamble; and adjusting a transmit power level for transmission at least partially based on the preamble bit length of the preamble.

Example 30: An apparatus comprising: a transceiver including: a preamble bit length detector circuit to detect a preamble bit length of a preamble of a first message of a first communication signal; a transmitter amplifier; a gain adjustment circuit to adjust a gain of the transmitter amplifier at least partially based on the detected preamble bit length; and the transmitter amplifier to amplify, using the adjusted gain, a second communication signal including a second message for transmission.

Example 31: The apparatus according to Example 30, wherein the transceiver comprises a transceiver PHY including the preamble bit length detector circuit, the transmitter amplifier, and the gain adjustment circuit, and the preamble bit length detector circuit comprises a counter circuit to maintain a count of received bits of the preamble.

Example 32: The apparatus according to any of Examples 30 and 31, wherein: the preamble bit length detector circuit comprises a first counter circuit to maintain a count of received bits of the preamble to reach a total count of received bits of the preamble, the gain adjustment circuit comprises a second counter circuit to maintain a gain control count for adjustment of the gain of the transmitter amplifier, the second counter circuit to increment or decrement the gain control count at least partially based on the total count of received bits of the preamble from the first counter circuit, wherein the gain adjustment circuit is to repeat the adjusting of the gain at least partially based on respective ones of subsequently detected preamble bit lengths of subsequently received preambles.

Example 33: The apparatus according to any of Examples 30 through 32, wherein: the gain adjustment circuit to: decrease the gain of the transmitter amplifier at least partially based on the preamble bit length comprising a first preamble bit length; and increase the gain of the transmitter amplifier at least partially based on the preamble bit length comprising a second preamble bit length.

Example 34: The apparatus according to any of Examples 30 through 33, wherein: the gain adjustment circuit to: decrease the gain of the transmitter amplifier at least partially based on the preamble bit length comprising a first preamble bit length; maintain the gain of the transmitter amplifier at least partially based on the preamble bit length comprising a second preamble bit length; and increase the gain of the transmitter amplifier at least partially based on the preamble bit length comprising a third preamble bit length.

Example 35: The apparatus according to any of Examples 30 through 34, wherein: the second preamble bit length is A bits, the first preamble bit length is one of (A−Z) bits or (A+Z) bits, the third preamble bit length is the other one of (A−Z) bits or (A+Z) bits, and where A and Z are predetermined positive integer constants, where A>Z.

Example 36: The apparatus according to any of Examples 30 through 35, wherein: the transceiver including: a received signal strength detector to detect a signal strength of the first communication signal; a comparator circuit to compare the detected signal strength of the first communication signal with one or more thresholds; and a preamble sequence generator circuit to generate a preamble of the second message, the preamble sequence generator circuit to adjustably set a preamble bit length of the preamble at least partially based on one or more outputs of the comparator circuit.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method comprising:
at a transceiver,
receiving a first communication signal including a first message;
detecting a signal strength of the first communication signal;
generating a preamble having a preamble bit length that is adjusted at least partially based on the detected signal strength of the first communication signal; and
transmitting a second communication signal including a second message, the second message including the preamble having the preamble bit length.

2. The method of claim 1, comprising:
at the transceiver,
comparing the detected signal strength with one or more thresholds,
wherein the preamble bit length of the preamble is adjusted at least partially based on a result of the comparing.

3. The method of claim 2, comprising:
at the transceiver,
at least partially based on the result of the comparing indicating that the detected signal strength is greater than a threshold, generating the preamble having the preamble bit length comprising a first preamble bit length; and
at least partially based on the result of the comparing indicating that the detected signal strength is less than the threshold, generating the preamble having the preamble bit length comprising a second preamble bit length.

4. The method of claim 2, comprising:
at the transceiver,
at least partially based on the result of the comparing indicating that the detected signal strength is greater than a target threshold range, generating the preamble having the preamble bit length comprising a first preamble bit length, the target threshold range defined by the one or more thresholds;
at least partially based on the result of the comparing indicating that the detected signal strength is within the target threshold range, generating the preamble having the preamble bit length comprising a second preamble bit length; and
at least partially based on the result of the comparing indicating that the detected signal strength is less than the target threshold range, generating the preamble having the preamble bit length comprising a third preamble bit length.

5. The method of claim 4, wherein:
the second preamble bit length is A bits,
the first preamble bit length is one of (A−Z) bits or (A+Z) bits,
the third preamble bit length is the other one of (A−Z) bits or (A+Z) bits, and
where A and Z are predetermined positive integer constants, and A>Z.

6. The method of claim 5, wherein:
A bits=(X+Y) bits, and
where X and Y are predetermined positive integer constants, X is a predetermined preamble bit length of a preamble specified in a communication standard with which the transceiver is compatible, and Y>Z.

7. The method of claim 4, wherein:
the second preamble bit length is X bits,
the first preamble bit length is (X+J) bits,
the third preamble bit length is (X+K) bits, and
where X, J, and K are predetermined positive integer constants, X is a predetermined preamble bit length of a preamble specified in a communication standard with which the transceiver is compatible, and J≠K.

8. The method of claim 1, comprising:
at the transceiver,
detecting a preamble bit length of a preamble of the first message of the first communication signal; and
adjusting a transmit power level to transmit the second communication signal at least partially based on the preamble bit length of the first message.

9. The method of claim 8, comprising:
at the transceiver,
detecting a preamble bit length of a preamble of the first message of the first communication signal;
at least partially based on the preamble bit length comprising a first preamble bit length, decreasing the transmit power level to transmit the second communication signal;
at least partially based on the preamble bit length comprising a second preamble bit length, maintain the transmit power level to transmit the second communication signal; and
at least partially based on the preamble bit length comprising a third preamble bit length, increasing the transmit power level to transmit the second communication signal.

10. The method of claim 1, wherein the preamble having the preamble bit length comprises an instruction to another transceiver to adjust a transmit power level for transmission according to the preamble bit length.

11. An apparatus comprising:
a transceiver including:
a received signal strength indicator circuit to detect a signal strength of a first communication signal including a first message;
a comparator circuit to compare the detected signal strength of the first communication signal with one or more thresholds; and
a preamble sequence generator circuit to generate a preamble of a second message of a second communication signal for transmission, the preamble sequence generator circuit to adjustably set a preamble bit length of the preamble at least partially based on one or more outputs of the comparator circuit.

12. The apparatus of claim 11, wherein:
the preamble sequence generator circuit to:
generate the preamble having the preamble bit length comprising a first preamble bit length at least partially based on the one or more outputs of the comparator circuit indicating that the detected signal strength is greater than a threshold; and
generate the preamble having the preamble bit length comprising a second preamble bit length at least partially based on the one or more outputs of the comparator circuit indicating that the detected signal strength is less than the threshold.

13. The apparatus of claim 11, wherein:
the preamble sequence generator circuit to:
generate the preamble having the preamble bit length comprising a first preamble bit length at least partially based on the one or more outputs of the comparator circuit indicating the detected signal strength is greater than a target threshold range, the target threshold range defined by the one or more thresholds;
generate the preamble having the preamble bit length comprising a second preamble bit length at least partially based on to the one or more outputs of the comparator circuit indicating the detected signal strength is within the target threshold range; and
generate the preamble having the preamble bit length comprising a third preamble bit length at least partially based on the one or more outputs of the comparator circuit indicating the detected signal strength is less than the target threshold range.

14. The apparatus of claim 13, wherein:
the second preamble bit length is A bits,
the first preamble bit length is one of (A−Z) bits or (A+Z) bits,
the third preamble bit length is the other one of (A−Z) bits or (A+Z) bits, and
where A and Z are predetermined positive integer constants, where A>Z.

15. The apparatus of claim 11, wherein the transceiver comprises a transceiver PHY including the receiver signal strength indicator circuit, the comparator circuit, and the preamble sequence generator circuit, the apparatus comprising:
an analog-to-digital converter to convert an analog value of the detected signal strength to a digital value, the analog-to-digital converter to provide the digital value of the detected signal strength to an input of the comparator circuit.

16. The apparatus of claim 11, wherein:
the transceiver including:
a preamble bit length detector circuit to detect a preamble bit length of a preamble of the first message of the first communication signal;
a transmitter amplifier;
a gain adjustment circuit to adjust a gain of the transmitter amplifier at least partially based on the detected preamble bit length; and
the transmitter amplifier to amplify, with the adjusted gain, a second communication signal including a second message for transmission.

17. The apparatus of claim 16, wherein:
the gain adjustment circuit to decrease the gain of the transmitter amplifier at least partially based on the preamble bit length comprising a first preamble bit length, the gain adjustment circuit to increase the gain of the transmitter amplifier at least partially based on the preamble bit length comprising a second preamble bit length.

18. The apparatus of claim 16, wherein:
the preamble bit length detector circuit includes a first counter circuit to maintain a count of received bits of the preamble to reach a total count of received bits of the preamble, and
the gain adjustment circuit includes a second counter circuit to maintain a gain control count for adjustment of the gain of the transmitter amplifier, the second counter circuit to increment or decrement the gain control count at least partially based on the total count of received bits of the preamble from the first counter circuit.

19. A method comprising:
at a transceiver,
receiving a first communication signal including a first message;
detecting a preamble bit length of a preamble of the first message;
adjusting a gain of a transmitter amplifier of the transceiver at least partially based on the preamble bit length of the preamble;
amplifying, with the transmitter amplifier having the adjusted gain, a second communication signal including a second message; and
transmitting the amplified second communication signal including the second message.

20. The method of claim 19, comprising:
at the transceiver,
at least partially based on the preamble bit length comprising a first preamble bit length, decreasing the gain of the transmitter amplifier to transmit the amplified second communication signal; and
at least partially based on the preamble bit length comprising a second preamble bit length, increasing the gain of the transmitter amplifier to transmit the amplified second communication signal.

21. The method of claim 19, comprising:
at the transceiver,
at least partially based on the preamble bit length comprising a first preamble bit length, decreasing the gain of the transmitter amplifier to transmit the amplified second communication signal;
at least partially based on the preamble bit length comprising a second preamble bit length, maintaining the gain of the transmitter amplifier to transmit the amplified second communication signal; and
at least partially based on the preamble bit length comprising a third preamble bit length, increasing the gain of the transmitter amplifier to transmit the amplified second communication signal.

22. The method of claim 21, wherein:
the second preamble bit length is A bits,
the first preamble bit length is one of (A−Z) bits or (A+Z) bits,
the third preamble bit length is the other one of (A−Z) bits or (A+Z) bits, and
where A and Z are predetermined positive integer constants, where A>Z.

23. The method of claim 19, wherein:
detecting the preamble bit length of the preamble comprises maintaining a count of received bits of the preamble to reach a total count of the received bits of the preamble, and
adjusting the gain of the transmitter amplifier comprises adjusting the gain of the transmitter amplifier at least partially based on the total count of received bits of the preamble.

24. The method of claim 19, wherein:
detecting the preamble bit length of the preamble comprises maintaining a count of received bits of the preamble to reach a total count of received bits of the preamble,
adjusting the gain of the transmitter amplifier comprises incrementing or decrementing a gain control count for adjustment of the gain at least partially based on the total count of received bits of the preamble, and
repeating the adjusting, the amplifying, and the transmitting at least partially based on respective ones of subsequently detected preamble bit lengths of subsequently received preambles.

25. The method of claim 19, comprising:
at the transceiver,
detecting a signal strength of the first communication signal; and
generating a preamble having a preamble bit length that is adjusted at least partially based on the detected signal strength,
wherein transmitting the amplified second communication signal comprises transmitting the amplified second communication signal including the second message with the preamble having the preamble bit length.

26. The method of claim 25, comprising:
at the transceiver,
comparing the detected signal strength with one or more thresholds,
wherein the preamble bit length of the preamble of the second message is adjusted at least partially based on a result of the comparing.

27. The method of claim 26, comprising:
at the transceiver,
at least partially based on the result of the comparing indicating that the detected signal strength is greater than a target threshold range, generating the preamble having the preamble bit length comprising a first preamble bit length, the target threshold range defined by the one or more thresholds;
at least partially based on the result of the comparing indicating that the detected signal strength is within the target threshold range, generating the preamble having the preamble bit length comprising a second preamble bit length; and
at least partially based on the result of the comparing indicating that the detected signal strength is less than the target threshold range, generating the preamble having the preamble bit length comprising a third preamble bit length.

28. The method of claim 25, wherein the preamble having the preamble bit length in the second message comprises an instruction to another transceiver to adjust a transmit power level for transmission according to the preamble bit length.

29. The method of claim 25, comprising:
at another transceiver,
receiving the second communication signal including the second message having the preamble; and
adjusting a transmit power level for transmission at least partially based on the preamble bit length of the preamble.

30. An apparatus comprising:
a transceiver including:
a preamble bit length detector circuit to detect a preamble bit length of a preamble of a first message of a first communication signal;
a transmitter amplifier;
a gain adjustment circuit to adjust a gain of the transmitter amplifier at least partially based on the detected preamble bit length; and
the transmitter amplifier to amplify, using the adjusted gain, a second communication signal including a second message for transmission.

31. The apparatus of claim 30, wherein the transceiver comprises a transceiver PHY including the preamble bit length detector circuit, the transmitter amplifier, and the gain adjustment circuit, and the preamble bit length detector circuit comprises a counter circuit to maintain a count of received bits of the preamble.

32. The apparatus of claim 30, wherein:
the preamble bit length detector circuit comprises a first counter circuit to maintain a count of received bits of the preamble to reach a total count of received bits of the preamble,
the gain adjustment circuit comprises a second counter circuit to maintain a gain control count for adjustment of the gain of the transmitter amplifier, the second counter circuit to increment or decrement the gain control count at least partially based on the total count of received bits of the preamble from the first counter circuit,
wherein the gain adjustment circuit is to repeat the adjusting of the gain at least partially based on respective ones of subsequently detected preamble bit lengths of subsequently received preambles.

33. The apparatus of claim 30, wherein:
the gain adjustment circuit to:
decrease the gain of the transmitter amplifier at least partially based on the preamble bit length comprising a first preamble bit length; and
increase the gain of the transmitter amplifier at least partially based on the preamble bit length comprising a second preamble bit length.

34. The apparatus of claim 30, wherein:
the gain adjustment circuit to:
decrease the gain of the transmitter amplifier at least partially based on the preamble bit length comprising a first preamble bit length;
maintain the gain of the transmitter amplifier at least partially based on the preamble bit length comprising a second preamble bit length; and
increase the gain of the transmitter amplifier at least partially based on the preamble bit length comprising a third preamble bit length.

35. The apparatus of claim 34, wherein:
the second preamble bit length is A bits,
the first preamble bit length is one of (A−Z) bits or (A+Z) bits,
the third preamble bit length is the other one of (A−Z) bits or (A+Z) bits, and
where A and Z are predetermined positive integer constants, where A>Z.

36. The apparatus of claim 30, wherein:
the transceiver including:
a received signal strength detector to detect a signal strength of the first communication signal;
a comparator circuit to compare the detected signal strength of the first communication signal with one or more thresholds; and
a preamble sequence generator circuit to generate a preamble of the second message, the preamble sequence generator circuit to adjustably set a preamble bit length of the preamble at least partially based on one or more outputs of the comparator circuit.
